(19) United States
(12) Patent Application Publication
(10) Pub. No.: US 2024/0008138 A1
(43) Pub. Date: Jan. 4, 2024

(54) METHOD AND DEVICE FOR WIRELESS COMMUNICATION

(71) Applicants: Yu CHEN, Shanghai (CN); Xiaobo ZHANG, Shanghai (CN)

(72) Inventors: Yu CHEN, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/212,189

(22) Filed: Jun. 21, 2023

(30) Foreign Application Priority Data
Jun. 29, 2022 (CN) 202210784707.0
Jul. 7, 2022 (CN) 202210802634.3
Sep. 13, 2022 (CN) 202211109374.8

(51) Int. Cl. H04W 76/28; H04W 52/02

(52) U.S. Cl. CPC H04W 76/28; H04W 52/0245

(57) ABSTRACT

Disclosure provides a method and device for wireless communications, comprising receiving a first signaling, the first signaling comprising a first parameter set, and the first parameter set being used to configure a DRX of a first cell group; the DRX configured by the first parameter set being for a first MAC entity; and within an active time of the first MAC entity, monitoring a PDCCH; executing a first link quality evaluation, a time of the behavior of executing a first link quality evaluation being a first evaluation period; wherein the first parameter set comprises a first time length set, and the first time length set comprises at least a first time length; any time length in the first time length set is a long DRX cycle. The present application is advantageous in supporting more flexible DRX and ensuring the performance of link monitoring through a first signaling.

### CROSS REFERENCE TO RELATED APPLICATIONS

This application claims the priority benefit of Chinese Patent Application 202210784707.0, filed on Jun. 29,2022; and claims the priority benefit of Chinese Patent Application 202210802634.3, filed on Jul. 7,2022; and claims the priority benefit of Chinese Patent Application 202211109374.8, filed on Sep. 13,2022, the full disclosure of which is incorporated herein by reference.

### BACKGROUND

### Technical Field

The present application relates to transmission methods and devices in wireless communication systems, involving the improvement of traffic service quality and interactive service transmission, and particularly to a method and device for XR traffic.

### Related Art

Application scenarios of future wireless communication systems are becoming increasingly diversified, and different application scenarios have different performance demands on systems. In order to meet different performance requirements of various application scenarios, 3rd Generation Partner Project (3GPP) Radio Access Network (RAN) #72 plenary decided to conduct the study of New Radio (NR), or what is called fifth Generation (5G). A work Item (WI) of NR was approved at 3GPP RAN #75 plenary to standardize NR.

In communications, whether Long Term Evolution (LTE) or 5G NR involves features of accurate reception of reliable information, optimized energy efficiency ratio, determination of information efficiency, flexible resource allocation, scalable system structure, efficient non-access layer information processing, low service interruption and dropping rate and support for low power consumption, which are of great significance to the maintenance of normal communications between a base station and a UE, reasonable scheduling of resources and balancing of system payload. Those features can be called the cornerstone of high throughout and are characterized in meeting communication requirements of various service, improving spectrum utilization and improving service quality, which are indispensable in enhanced Mobile BroadBand (eMBB), Ultra Reliable Low Latency Communications (URLLC) and enhanced Machine Type Communications (eMTC). Meanwhile, in the following communication modes, covering Industrial Internet of Things (IIoT), Vehicular to X (V2X), Device to Device communications, Unlicensed Spectrum communications, User communication quality monitoring, network planning optimization, Non-Territorial Networks (NTN), Territorial Networks (TN), and Dual connectivity system, there are extensive requirements in radio resource management and selection of multi-antenna codebooks as well as in signaling design, adjacent cell management, service management and beamforming. Transmission methods of information are divided into broadcast transmission and unicast transmission, both of which are essential for 5G system for that they are very helpful to meet the above requirements. The UE can be connected to the network directly or through a relay.

With the increase of scenarios and complexity of systems, higher requirements are raised for interruption rate and time delay reduction, reliability and system stability enhancement, service flexibility and power saving. At the same time, compatibility between different versions of different systems should be considered when designing the system.

3GPP standardization organization has carried out relevant standardization work for 5G and formed a series of standards, which can be referred to as follows:
https://www.3gpp.org/ftp/Specs/archive/38_series/380.331/38331-g60.zip
https://www.3gpp.org/ftp/Specs/archive/38_series/38.331/38321-g60.zip

### SUMMARY

In the communication system, a research project on XR traffic is added in version 18 of 3GPP. XR traffic comprises Virtual Reality (VR) traffic, Augmented Reality (AR) traffic, and Cloud Games (CG) traffic, which has the characteristics of high speed and low latency, and at the same time, has strict requirements for traffic response time for being interactive service. On the one hand, XR traffic often involves high-speed and high-definition time-frequency transmission, which consumes a lot of power and requires support for Discontinuous Reception (DRX) to save electricity; on the other hand, due to the inherent attributes and requirements of an arrival of traffic data, for example, data of one type of traffic may need to be transmitted every 16.67 milliseconds, while the existing DRX mechanism cannot adapt to such requirements. If an approximate value is used, a user is awakened every 16 milliseconds, then after a period of accumulation, the occasion of waking up and an actual time to transmit the traffic will become increasingly staggered, which means that the user need to wait for a long time to receive traffic data after waking up, in the case, a DRX will be difficult to save power. Therefore, it is necessary to design a matching power-saving mechanism for XR or traffic with similar requirements to support, such as a non-integral transmission cycle. Researchers have found that if multiple DRX cycles are configured, such as mixing 16 ms and 17 ms DRX cycles, or multiple active time windows are configured through templates within a longer cycle, such as configuring 3 active time windows within 50 ms, more flexible DRX cycle can be achieved, such as a DRX cycle of 16.67 ms. However, the DRX cycle involves other aspects besides power saving effect. In a signal measurement, the DRX cycle is an important parameter that affects a series of measurement indicators and behavior of the measurement, which can lead to inconsistency between the terminal and the network if ambiguity or confusion occurs, thereby affecting performance and even causing dropped calls. For example, if both 16 ms and 17 ms DRX cycles are configured, this inconsistency will occur if the terminal uses 16 ms while the network considers it to be 16.67 ms. Therefore, how to enable the signal measurement function to support a new DRX and further support XR traffic is a problem that needs to be addressed.

To address the above problem, the present application provides a solution.

It should be noted that if no conflict is incurred, embodiments in any node in the present application and the characteristics of the embodiments are also applicable to any other node, and vice versa. And the embodiments in the present application and the characteristics in the embodiments can be arbitrarily combined if there is no conflict. At the same time, the method proposed in the present application can also be used to solve other problems in communications.

The present application provides a method in a first node for wireless communications, comprising:
receiving a first signaling, the first signaling comprising a first parameter set, the first parameter set being used to configure a Discontinuous Reception (DRX) of a first cell group; the DRX configured by the first parameter set is for a first MAC entity;
within an active time of the first MAC entity, monitoring a PDCCH;
executing a first link quality evaluation, a time of the behavior of executing a first link quality evaluation being a first evaluation period;
herein, the first parameter set comprises a first time length set, and the first time length set comprises at least a first time length; any time length in the first time length set is a first-type DRX cycle; a system frame number, a subframe number, and the first time length set are used together to determine a first time window set; the active time of the first MAC entity comprises the first time window set; a target DRX cycle is used to determine the first evaluation period; the target DRX cycle is related to whether a time interval between any two adjacent time windows in the first time window set is equal; when a time interval between any two adjacent time windows in the first time window set is equal, the target DRX cycle is equal to the first time length; when a time interval between any two adjacent time windows in the first time window set is a candidate time interval in a first candidate time interval set and the first candidate time interval set comprises at least a first time interval and a second time interval, the target DRX cycle is equal to a second time length; the first time length is not equal to the second time length; a DRX configured by the first parameter set is unrelated to Point to Multipoint (PTM).

In one embodiment, a problem to be solved in the present application comprises: how to make physical layer signal measurement or monitoring support a more flexible DRX.

In one embodiment, advantages of the above method comprise: it has good flexibility, supports more diverse traffic, has lower implementation complexity, prolongs battery life, ensures communication quality, and avoids dropped calls at the same time.

Specifically, according to one aspect of the present application, the first time length set is used to determine the second time length;
herein, the meaning of the phrase that the first time length set is used to determine the second time length is: the second time length is an extreme value of a time length comprised in the first time length set; the first time length set comprises multiple time lengths.

Specifically, according to one aspect of the present application, the first time length set is used to determine the second time length;
herein, the meaning of the phrase that the first time length set is used to determine the second time length is: the second time length is an average value of time lengths comprised in the first time length set; the first time length set comprises multiple time lengths.

Specifically, according to one aspect of the present application, the first signaling comprises the second time length.

Specifically, according to one aspect of the present application, the first time length set only comprises the first time length; a number of DRX(s) configured in the first parameter set is K, where K is a positive integer greater than 1; the first time length and K are used together to determine the second time length.

Specifically, according to one aspect of the present application, any time window within the first time window set corresponds to a running of a first-type DRX timer; a name of the first-type DRX timer comprises onduration.

Specifically, according to one aspect of the present application, the first time length set only comprises the first time length; any DRX cycle determined by the first time length comprises K time windows in the first time window set, and the first time length and K are used together to determine the second time length.

Specifically, according to one aspect of the present application, the meaning of the phrase that a target DRX cycle is used to determine the first evaluation period comprises: the target DRX cycle and a first coefficient are used together to determine the first evaluation period, when a time interval between any two adjacent time windows in the first time window set is equal, the first coefficient is equal to 1; when a time interval between any two adjacent time windows in the first time window set is a candidate time interval in a first candidate time interval set and the first candidate time interval set comprises at least a first time interval and a second time interval, the first coefficient is not equal to 1.

Specifically, according to one aspect of the present application, a first indication interval is a minimum interval between two adjacent evaluation results of the first link quality evaluation indicated by a physical layer of the first node to a higher layer;
the target DRX cycle is used to determine the first indication interval.

Specifically, according to one aspect of the present application, the first node is an IoT terminal.

Specifically, according to one aspect of the present application, the first node is a UE.

Specifically, according to one aspect of the present application, the first node is a relay.

Specifically, according to one aspect of the present application, the first node is an access network device.

Specifically, according to one aspect of the present application, the first node is a vehicle terminal.

Specifically, according to one aspect of the present application, the first node is an aircraft.

Specifically, according to one aspect of the present application, the first node is a mobile phone.

The present application provides a first node for wireless communications, comprising:
a first receiver, receiving a first signaling, the first signaling comprising a first parameter set, the first parameter set being used to configure a DRX of a first cell group; the DRX configured by the first parameter set being for a first MAC entity;
the first receiver, within an active time of the first MAC entity, monitoring a PDCCH; and
the first receiver, executing a first link quality evaluation, a time of the behavior of executing a first link quality evaluation being a first evaluation period;
herein, the first parameter set comprises a first time length set, and the first time length set comprises at least a first time length; any time length in the first time length set is a first-type DRX cycle; a system frame number, a subframe number, and the first time length set are used together to determine a first time window set; the active time of the first MAC entity comprises the first time window set; a target DRX cycle is used to determine the first evaluation period; the target DRX cycle is related to whether a time interval between any two adjacent time windows in the first time window set is equal; when a time interval between any two adjacent time windows in the first time window set is equal, the target DRX cycle is equal to the first time length; when a time interval between any two adjacent time windows in the first time window set is a candidate time interval in a first candidate time interval set and the first candidate time interval set comprises at least a first time interval and a second time interval, the target DRX cycle is equal to a second time length; the first time length is not equal to the second time length; a DRX configured by the first parameter set is unrelated to PTM.

In one embodiment, the present application has the following advantages over conventional schemes:
it supports a more flexible DRX, such as supporting a non-integral DRX cycle.
it can support more diverse traffic types, such as XR traffic.
it can better meet the needs of XR traffic.
it ensures the performance of signal measurement or link monitoring, such as timely, effectively, and accurately generating a measurement result.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of receiving a first signaling, monitoring a PDCCH within an active time of the first MAC entity, and executing a first link quality evaluation according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of radio signal transmission according to one embodiment of the present application;

FIG. 6 illustrates a schematic diagram of a first time window set according to one embodiment of the present application;

FIG. 7 illustrates a schematic diagram of a first time window set according to one embodiment of the present application;

FIG. 8 illustrates a schematic diagram of a system frame number, a subframe number and a first time length set being used together to determine a first time window set according to one embodiment of the present application;

FIG. 9 illustrates a schematic diagram of a target DRX cycle being used to determine a first evaluation period according to one embodiment of the present application;

FIG. 10 illustrates a schematic diagram of a first time length and K being used together to determine a second time length according to one embodiment of the present application;

FIG. 11 illustrates a schematic diagram of a target DRX cycle being used to determine a first indication interval according to one embodiment of the present application;

FIG. 12 illustrates a schematic diagram of a processor in a first node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of receiving a first signaling, monitoring a PDCCH within an active time of the first MAC entity, executing a first link quality evaluation according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, a first node in the present application receives a first signaling in step 101; monitors a PDCCH within an active time of the first MAC entity in step 102; executes a first link quality evaluation in step 103.

herein, the first signaling comprises a first parameter set, the first parameter set is used to configure a DRX of a first cell group; the DRX configured by the first parameter set is for a first MAC entity; a time of the behavior of executing a first link quality evaluation is a first evaluation period; the first parameter set comprises a first time length set, and the first time length set comprises at least a first time length; any time length in the first time length set is a first-type DRX cycle; a system frame number, a subframe number, and the first time length set are used together to determine a first time window set; the active time of the first MAC entity comprises the first time window set; a target DRX cycle is used to determine the first evaluation period; the target DRX cycle is related to whether a time interval between any two adjacent time windows in the first time window set is equal; when a time interval between any two adjacent time windows in the first time window set is equal, the target DRX cycle is equal to the first time length; when a time interval between any two adjacent time windows in the first time window set is a candidate time interval in a first candidate time interval set and the first candidate time interval set comprises at least a first time interval and a second time interval, the target DRX cycle is equal to a second time length; the first time length is not equal to the second time length; a DRX configured by the first parameter set is unrelated to PTM.

In one embodiment, the first node is a User Equipment (UE).

In one embodiment, the first node is in RRC_CONNECTED state.

In one embodiment, a serving cell is or comprises a UE-camped cell. Executing a cell search comprises: a UE searches for a suitable cell of a selected Public Land Mobile Network (PLMN) or a Stand-alone Non-Public Network (SNPN), selects the suitable cell to provide available traffic, and monitors a control channel of the suitable cell, and this procedure is defined as camping on a cell; that is to say, a camped cell is a serving cell of the UE relative to the UE. It has the following advantages to camp on a cell in RRC idle state or RRC inactive state: enabling the UE to receive a system message from a PLMN or an SNPN; after registration, if the UE wishes to establish an RRC connection or continue a suspended RRC connection, the UE can achieve this by executing an initial access on a control channel of the camping cell; the network may page the UE, which enables the UE to receive Earthquake and Tsunami Warning System (ETWS) and Commercial Mobile Alert System (CMAS) notifications.

In one embodiment, for a UE in RRC_CONNECTED state not configured with carrier aggregation/dual connectivity (CA/DC), only one serving cell comprises a primary cell. For a UE in RRC_CONNECTED state configured with carrier aggregation/dual connectivity (CA/DC), a serving cell is used to indicate a cell set comprising a Special Cell (SpCell) and all sub-cells. A Primary Cell is a Master Cell Group (MCG) cell, which works at primary frequency, and the UE executes an initial connection establishment procedure or initiates a connection re-establishment on a primary cell. For dual connectivity operation, a special cell refers to a Primary Cell (PCell) of an MCG or a Primary SCG Cell (PSCell) of an SCG; if it is not a dual connectivity operation, an SpCell refers to a PCell.

In one embodiment, frequency at which a Secondary Cell (SCell) works is sub-frequency.

In one embodiment, individual content of an information element is called a field.

In one embodiment, a Multi-Radio Dual Connectivity (MR-DC) refers to a dual connectivity between an E-UTRA and an NR node, or a dual connectivity between two NR nodes.

In one embodiment, in MR-DC, a radio access node providing a control-plane connection to the core network is a master node, and the master node may be a master eNB, a master ng-eNB, or a master gNB.

In one embodiment, an MCG refers to, in MR-DC, a group of serving cells associated with a master node, comprising an SpCell, and optionally one or multiple SCells.

In one embodiment, a PCell is an SpCell of an MCG.

In one embodiment, a PSCell is an SpCell of an SCG.

In one embodiment, in MR-DC, a radio access node not providing control plane connectivity to the core network and providing extra resources to a UE is a secondary node; the secondary node can be an en-gNB, a secondary ng-eNB or a secondary gNB.

In one embodiment, in MR-DC, a group of serving cells associated with a secondary node is a Secondary Cell Group (SCG), comprising an SpCell and optionally, one or multiple SCells.

In one embodiment, the first signaling is not transmitted via a sidelink.

In one embodiment, the first signaling is transmitted through a link other than sidelink.

In one embodiment, the first signaling is transmitted through a main link.

In one embodiment, a transmitter of the first signaling is an MCG of the first node.

In one embodiment, a transmitter of the first signaling is a PCell of the first node.

In one embodiment, a generator of the first signaling is a PCell of the first node.

In one embodiment, a transmitter of the first signaling is a serving cell of the first node.

In one embodiment, the first signaling is an RRC signaling.

In one embodiment, the first signaling is or comprises a MAC CE.

In one embodiment, the first signaling comprises a MAC CE signaling and an RRC signaling.

In one embodiment, the first signaling comprises an RRCReconfiguration.

In one embodiment, the first signaling comprises RRCConnectionReconfiguration.

In one embodiment, the first signaling is for one of DRX-Config2 or DRX-Config.

In one embodiment, the first signaling comprises at least partial fields in CellGroupConfig.

In one embodiment, the first signaling comprises at least partial fields in MAC-CellGroupConfig.

In one embodiment, the first signaling is one of DRX-ConfigSecondaryGroup or DRX-Config.

In one embodiment, the first signaling is or comprises DRX-ConfigExt.

In one embodiment, the first signaling is or comprises DRX-ConfigXR.

In one embodiment, the first signaling is or comprises DRX-ConfigExt2.

In one embodiment, the first signaling is or comprises DRX-ConfigExt3.

In one embodiment, the first signaling is or comprises a first field, and a name of the first field comprises “DRX-Config”.

In one subembodiment of the embodiment, the first field is not DRX-ConfigSecondaryGroup.

In one subembodiment of the embodiment, the first signaling comprises DRX-Config.

In one embodiment, the first signaling does not comprise DRX-Config.

In one embodiment, the first signaling is or comprises a first field, and a name of the first field comprises “DRX-Config”.

In one subembodiment of the embodiment, the first field is not DRX-Config.

In one subembodiment of the embodiment, the first signaling comprises DRX-ConfigSecondaryGroup.

In one embodiment, the first signaling only comprises one of DRX-ConfigSecondaryGroup or DRX-Config.

In one embodiment, the first signaling is transmitted by unicast.

In one embodiment, a first signaling uses a dedicated control channel (DCCH) for transmission.

In one embodiment, parameters comprised in the first parameter set are related to DRX.

In one embodiment, a name of a parameter comprised in the first parameter set comprises DRX.

In one embodiment, parameters comprised in the first parameter set correspond to a field comprised in the first signaling.

In one embodiment, the first cell group is either an MCG or an SCG.

In one embodiment, the DRX-ConfigSecondaryGroup is only for an SCG.

In one embodiment, the DRX-Config is only for an MCG.

In one embodiment, the meaning of the phrase that the first parameter set is used to configure a DRX of a first cell group comprises: the first parameter set is for the first cell group.

In one embodiment, the meaning of the phrase that the first parameter set is used to configure a DRX of a first cell group comprises: the first parameter set comprises at least one parameter for a DRX of the first cell group.

In one embodiment, the meaning of the phrase that the first parameter set is used to configure a DRX of a first cell group comprises: the first parameter set is used to configure a DRX of the first cell group.

In one embodiment, the behavior of monitoring a physical downlink control channel (PDCCH) comprises: performing blind detection on resources occupied by a PDCCH.

In one embodiment, the behavior of monitoring a physical downlink control channel (PDCCH) comprises: performing baseband processing on resources occupied by a PDCCH to obtain a bit block.

In one embodiment, the behavior of monitoring a physical downlink control channel (PDCCH) comprises: performing demodulation on resources occupied by a PDCCH.

In one embodiment, the behavior of monitoring a physical downlink control channel (PDCCH) comprises: performing blind decoding on a bit block carried by a PDCCH.

In one embodiment, the behavior of monitoring a physical downlink control channel (PDCCH) comprises: performing descrambling for a bit block on a PDCCH.

In one embodiment, the behavior of monitoring a physical downlink control channel (PDCCH) comprises: performing a CRC check for a bit block on a PDCCH.

In one embodiment, the behavior of monitoring a physical downlink control channel (PDCCH) comprises: receiving downlink control information on a PDCCH.

In one embodiment, the behavior of monitoring a physical downlink control channel (PDCCH) comprises: receiving downlink control information scrambled by a C-RNTI of the first node on a PDCCH.

In one embodiment, the behavior of monitoring a physical downlink control channel (PDCCH) comprises: receiving downlink control information for the first node on a PDCCH.

In one embodiment, the first parameter set comprises a first time length.

In one embodiment, the first time length set comprises a first time length.

In one embodiment, a name of a field used to indicate the first time length in the first signaling comprises “cycle”.

In one embodiment, a name of a field used to indicate the first time length in the first signaling comprises “drx”.

In one embodiment, a candidate value of the first time length is 50 ms.

In one embodiment, a time unit of the first time length is ms.

In one embodiment, the first time length is a length of a DRX cycle.

In one embodiment, the first time length is a length of a DRX cycle indicated by the first parameter set.

In one embodiment, DRX in the present application comprises eDRX.

In one embodiment, the first time length is a length of a long DRX cycle.

In one embodiment, the meaning of the phrase that a DRX configured by the first parameter set is for a same MAC entity comprises: the same MAC entity is a MAC entity for the first cell group.

In one embodiment, the first cell group has and only has a MAC entity.

In one embodiment, the meaning of the phrase that a DRX configured by the first parameter set is for a same MAC entity comprises: the first DRX group set is for the same MAC entity.

In one embodiment, the meaning of the phrase that a DRX configured by the first parameter set is for a same MAC entity comprises: a DRX configured by the first parameter set is executed by a same MAC entity.

In one embodiment, the meaning of the phrase that a DRX configured by the first parameter set is for a same MAC entity comprises: a MAC entity executes DRX configured by the first parameter set.

In one embodiment, the meaning of the phrase that a DRX configured by the first parameter set is for a same MAC entity comprises: a MAC entity processes an active time of the first DRX group set.

In one embodiment, the meaning of the phrase that a DRX configured by the first parameter set is for a same MAC entity is or comprises: the first parameter set is for a cell group, that is, for the first cell group.

In one embodiment, the system frame number is SFN.

In one embodiment, the subframe number is subframe number.

In one embodiment, a DRX configured by the first parameter set is a long DRX.

In one embodiment, the DRX configured by the first parameter set is a long DRX.

In one embodiment, time windows comprised in the first time window set are orthogonal in time domain.

In one embodiment, any two time windows comprised in the first time window set are orthogonal in time domain.

In one embodiment, any two time windows comprised in the first time window set are non-overlapping in time domain.

In one embodiment, any two time windows comprised in the first time window set are discontinuous in time domain. In one embodiment, the first parameter set is for a DRX group.

In one embodiment, a length of any time window in the first time window set is limited.

In one embodiment, time windows comprised in the first time window set are limited.

In one embodiment, time windows comprised in the first time window set can be infinite, which depends on power and/or RRC state and/or traffic requirements of the first node.

In one embodiment, the DRX cycle is a long-DRX cycle.

In one embodiment, the first parameter set comprises a length of any time window in the first time window set.

In one embodiment, lengths of all time windows in the first time window set are equal.

In one embodiment, the first time window set comprises two time windows with unequal length.

In one embodiment, the first time window set comprises a first time window and a second time window.

In one embodiment, the first time window and the second time window are two adjacent time windows.

In one embodiment, the first time window and the second time window are two non-adjacent time windows.

In one embodiment, the first time window and the second time window are any two time windows.

In one embodiment, the first time window and the second time window are two time windows belonging to a same DRX cycle.

In one embodiment, the first time window is an earliest time window belonging to a DRX cycle in the first time window set.

In one embodiment, a first offset is a time interval between the first time window and the second time window.

In one embodiment, the first parameter set comprises a first offset set

In one embodiment, a DRX group comprises a DRX subgroup.

In one embodiment, a DRX group comprises K DRX subgroups, where K is greater than 1.

In one embodiment, any serving cell can belong to the K DRX subgroups at the same time.

In one embodiment, any serving cell can belong to at least two DRX subgroups in the K DRX subgroups at the same time.

In one embodiment, there exists at least one serving cell can belong to the K DRX subgroups at the same time.

In one embodiment, there exists at least one serving cell can belong to at least two DRX subgroups in the K DRX subgroups at the same time.

In one embodiment, the first parameter set comprises a first time length set, and the first time length is one of the first time length sets.

In one embodiment, the first time length set comprises at least two time lengths.

In one subembodiment of the embodiment, the first time length set comprises K time lengths.

In one subembodiment of the embodiment, the first time length set comprises K−1 time length(s).

In one subembodiment of the embodiment, the first time length set comprises K+1 time length(s).

In one subembodiment of the embodiment, the first time length is for a first offset in the first offset set.

In one subembodiment of the embodiment, a time length other than the first time length in the first time length set is for an offset other than a first offset in the first offset set.

In one subembodiment of the embodiment, there exists a one-to-one corresponding relation between a time length in the first time length set and an offset in the first offset set.

In one embodiment, a field in the first signaling whose name comprises XR indicates the first offset set.

In one embodiment, the behavior of monitoring a PDCCH within an active time of the first MAC entity comprises: receiving a first specific DCI within the first specific time window, the first specific DCI is downlink control information, and a DCI format of the first specific DCI is a first format.

In one subembodiment of the embodiment, the first format is one of 0_0, 0_1, 0_2, 1_0, 1_1 and 1_2.

In one subembodiment of the embodiment, the first format is one of 2_0, 2_1, 2_2, 2_3, 2_4 and 2_ 5.

In one subembodiment of the embodiment, the first format is one of 3_ 0, and 3_1.

In one subembodiment of the embodiment, the first format is one of 2_7, 2_8 and 2_9.

In one subembodiment of the embodiment, the first format is not 2_6.

In one subembodiment of the embodiment, a C-RNTI of the first node is used to scramble the first specific DCI.

In one embodiment, the first time window set is for a DRX cycle.

In one embodiment, the first time window set is for multiple DRX cycles.

In one embodiment, any offset comprised in the first offset set is an offset in time domain.

In one embodiment, any offset comprised in the first offset set is measured by millisecond.

In one embodiment, any offset comprised in the first offset set is measured by slot.

In one embodiment, any offset comprised in the first offset set is measured by subframe.

In one embodiment, any offset comprised in the first offset set is measured by frame.

In one embodiment, any offset comprised in the first offset set is measured by symbol.

In one embodiment, any offset comprised in the first offset set represents an integer number of time unit(s).

In one embodiment, a first offset comprised in the first offset set is a real number of time unit(s) and not an integer number of time unit(s).

In one embodiment, any offset comprised in the first offset set is scalar.

In one embodiment, the first offset set comprises K offsets.

In one subembodiment of the above embodiment, K is equal to 1.

In one subembodiment of the above embodiment, K is equal to 2.

In one subembodiment of the above embodiment, K is equal to 3

In one subembodiment of the above embodiment, a value of K is greater than 3.

In one subembodiment of the above embodiment, a value of K is not greater than 16.

In one subembodiment of the above embodiment, a value of K is not greater than 64.

In one subembodiment of the above embodiment, a value of K is related to a number of QoS flow(s) of the first node.

In one embodiment, the meaning of the phrase that a DRX configured by the first parameter set is for a first MAC entity comprises: a DRX configured by the first parameter set is only valid for a first MAC entity, and the first MAC entity corresponds to the first cell group.

In one embodiment, the meaning of the phrase that a DRX configured by the first parameter set is for a first MAC entity comprises: the first MAC entity is a MAC entity corresponding to the first cell group, and the first cell group only has one corresponding MAC entity.

In one embodiment, the meaning of the phrase that a DRX configured by the first parameter set is for a first MAC entity comprises: a DRX configured by the first parameter set is for a DRX group, the DRX group is for the first cell group, the first MAC entity is a MAC entity corresponding to the first cell group, and the first cell group only has one corresponding MAC entity.

In one embodiment, the meaning of the phrase that a DRX configured by the first parameter set is for a first MAC entity comprises: a DRX configured by the first parameter set is for a DRX group, and a MAC entity that the DRX group is for is the first MAC entity.

In one embodiment, the meaning of the phrase that a DRX configured by the first parameter set is for a first MAC entity comprises: a DRX configured by the first parameter set is for a DRX group, and a MAC entity corresponding to the DRX group is the first MAC entity.

In one embodiment, the meaning of the phrase that a DRX configured by the first parameter set is for a first MAC entity comprises: a DRX of the first MAC entity is configured by the first parameter set.

In one embodiment, the meaning of the phrase that within an active time of the first MAC entity is or comprises: within an active time of a DRX group associated with the first MAC entity.

In one embodiment, the meaning of the phrase that within an active time of the first MAC entity is or

comprises: within an active time of a DRX group corresponding to the first MAC entity.

In one embodiment, the meaning of the phrase that within an active time of the first MAC entity is or comprises: within an active time of a DRX group corresponding to a cell group corresponding to the first MAC entity.

In one embodiment, the meaning of the phrase that within an active time of the first MAC entity is or comprises: within an active time of all DRX groups corresponding to a cell group corresponding to the first MAC entity.

In one embodiment, the meaning of the phrase that within an active time of the first MAC entity is or comprises: all DRX groups corresponding to a cell group corresponding to the first MAC entity are within an active time.

In one embodiment, a DRX group is activated, which means: a node is required to monitor a PDCCH.

In one embodiment, a DRX group is activated, which means: a node is in an awake state.

In one embodiment, the meaning of the phrase that any time length in the first time length set is a first-type DRX cycle comprises: any time length in the first time length set is a DRX cycle in a DRX configuration, and the DRX configuration is a long DRX.

In one embodiment, the meaning of the phrase that any time length in the first time length set is a first-type DRX cycle comprises: when the first node is configured with a long DRX cycle, the first time length set only comprises a time length of the first time length; when the first node is configured with K1 long DRX cycles, the first time length set comprises K1 time lengths, where K1 is a positive integer greater than 1.

In one embodiment, a candidate value of the first time length comprises 16 ms.

In one embodiment, a candidate value of the first time length comprises 17 ms.

In one embodiment, a candidate value of the first time length comprises 50 ms.

In one embodiment, the first time length set at least comprises 16 ms and 17 ms.

In one embodiment, the meaning of the phrase that the active time of the first MAC entity comprises the first time window set comprises: any time window in the first time window set belongs to an active time of the first MAC entity.

In one embodiment, the meaning of the phrase that the active time of the first MAC entity comprises the first time window set comprises: an active time of the first MAC entity comprises any time window in the first time window set.

In one embodiment, the meaning of the phrase that the active time of the first MAC entity comprises the first time window set comprises: within any time window in the first time window set, the first MAC entity is in an active time.

In one embodiment, the meaning of the phrase that the active time of the first MAC entity comprises the first time window set comprises: within any time window within the first time window set, a DRX group corresponding to a cell group corresponding to the first MAC entity is activated.

In one embodiment, any two time windows in the first time window set are sequential in time domain.

In one embodiment, any two adjacent time windows in the first time window set are two time windows with closest starts.

In one embodiment, any two adjacent time windows in the first time window set are two time windows with closest ends.

In one embodiment, the any two adjacent time windows in the first time window set is any time window in the first time window set and a time window in the first time window set whose start is closest to a start of the any time window.

In one embodiment, the any two adjacent time windows in the first time window set is any time window in the first time window set and a time window in the first time window set whose end is closest to an end of the any time window.

In one embodiment, the any two adjacent time windows in the first time window set is any time window in the first time window set and a time window in the first time window set whose start is closest to a start of the any time window but non-overlapping.

In one embodiment, the any two adjacent time windows in the first time window set is any time window in the first time window set and a time window in the first time window set whose end is closest to an end of the any time window but non-overlapping.

In one embodiment, any time window in the first time window set has adjacent time windows.

In one embodiment, the first time window set comprises at least 2 time windows.

Typically, the first time window set comprises at least 3 time windows.

In one embodiment, the any two adjacent time windows in the first time window set are two closest time windows in time domain.

In one embodiment, the any two adjacent time windows in the first time window set are two closest successive time windows in time domain.

In one embodiment, the first candidate time interval set comprises at least one time interval.

In one embodiment, the first offset set comprises K2 offset(s), and when K2 is greater than 1, the first candidate time interval set comprises at least two time intervals.

In one embodiment, a time interval between two adjacent time windows in the first time window set is the first time interval, and a time interval between the other two adjacent time windows in the first time window set is the second time interval.

In one subembodiment of the embodiment, the first time window set comprises at least 3 time windows.

In one subembodiment of the embodiment, the two adjacent time windows in the first time window set are different from the other two adjacent time windows in the first time window set.

In one subembodiment of the embodiment, at least one of the two adjacent time windows in the first time window set does not belong to the other two adjacent time windows in the first time window set.

In one embodiment, at least one time window within the first time window set is comprised in a period of any first time length.

Typically, the first time interval is 16 ms, and the second time interval is 17 ms.

In one embodiment, the target DRX cycle is one of multiple parameters that determines the first evaluation period.

In one embodiment, when a time interval between any two adjacent time windows in the first time window set is equal, the first time length set only comprises the first time length.

In one embodiment, when a set of time intervals consists of a time interval between any two adjacent time windows in the first time window set comprises at least two time intervals, the first time length set comprises more than one time length.

In one embodiment, the meaning of the phrase that when a time interval between any two adjacent time windows in the first time window set is a candidate time interval in a first candidate time interval set and the first candidate time interval set comprises at least a first time interval and a second time interval comprises: there exists a time interval between two adjacent time windows in the first time window set being the first time interval, and there exists a time interval between two adjacent time windows in the first time window set being the second time interval.

In one embodiment, the first time interval is not equal to the second time interval.

In one embodiment, the meaning of the phrase that a DRX configured by the first parameter set is unrelated to PTM is or comprises: a DRX configured by the first parameter set is for PTP.

In one embodiment, the meaning of the phrase that a DRX configured by the first parameter set is unrelated to PTM is or comprises: a DRX configured by the first parameter set is for unicast.

In one embodiment, the meaning of the phrase that a DRX configured by the first parameter set is unrelated to PTM is or comprises: a name of a DRX-related timer configured by the first parameter set does not comprise PTM.

In one embodiment, the meaning of the phrase that a DRX configured by the first signaling is unrelated to PTM is or comprises: a DRX configured by the first signaling is for a cell or a cell group instead of for an RNTI.

In one embodiment, the meaning of the phrase that a DRX configured by the first signaling is unrelated to PTM is or comprises: a DRX configured by the first signaling is unrelated to a G-RNTI.

In one embodiment, an SSB in the present application is an SS/PBCH.

In one embodiment, the behavior of executing a first link quality evaluation is or comprises radio link monitoring (RLM).

In one embodiment, the behavior of executing a first link quality evaluation is or comprises radio link recovery.

In one embodiment, the behavior of executing a first link quality evaluation is or comprises a beam failure detection.

In one embodiment, the behavior of executing a first link quality evaluation is or comprises link recovery.

In one embodiment, the behavior of performing a first link quality evaluation is or comprises link recovery for a specific Transmission Receipt Point (TRP).

In one embodiment, the behavior of executing a first link quality evaluation is or comprises measuring a first reference signal resource set, and the first reference signal resource set comprises a reference signal resource.

In one embodiment, the first reference signal resource set comprises SSB resources.

In one embodiment, the first reference signal resource set comprises a CSI-RS resource.

In one embodiment, the behavior of executing a first link quality evaluation is or comprises: measuring a first reference signal resource set and determining link quality based on whether a measurement result exceeds or does not meet a specific threshold.

In one embodiment, the behavior of executing a first link quality evaluation is or comprises: measuring a first reference signal resource set and determining whether to indicate to a higher layer above a physical layer based on whether a measurement result exceeds or does not meet a specific threshold.

In one embodiment, the behavior of executing a first link quality evaluation is or comprises: measuring a first reference signal resource set and determining whether to indicate to a higher layer above a physical layer based on whether a measurement result exceeds or does not meet a specific threshold.

In one embodiment, the behavior of executing a first link quality evaluation is or comprises: evaluating a first reference signal resource set.

In one embodiment, the behavior of executing a first link quality evaluation is or comprises: whenever evaluated radio link quality is worse than a first threshold, a physical layer of the first node reports a first-type indication to a higher layer of the first node.

In one embodiment, the behavior of executing a first link quality evaluation is or comprises: as a response to the higher layer of the first node continuously receiving Q1 first-type indications, starting the first timer, where Q1 is a positive integer.

In one embodiment, as a response to the first timer being expired, detect RLF.

In one embodiment, the first threshold is determined by the first node according to algorithm. In one embodiment, the first threshold is network-indicated.

In one embodiment, the first threshold is pre-configured.

In one embodiment, Q1 is network-indicated.

In one embodiment, the higher layer of the first node is a layer above a physical layer of the first node.

In one embodiment, the higher layer of the first node comprises a MAC layer.

In one embodiment, the higher layer of the first node comprises an RRC layer.

In one embodiment, the first reference signal resource set is configured by the first cell group.

In one embodiment, the first reference signal resource set is network-configured.

In one embodiment, the first-type indication is “out-of-sync”.

In one embodiment, the first-type indication is a beam failure example indication.

In one embodiment, the behavior of executing a first link quality evaluation is or comprises: as a response to the higher layer of the first node continuously receiving Q1 first-type indications, triggering a beam failure recovery.

In one embodiment, the first link quality evaluation is performed periodically.

In one embodiment, the first link quality evaluation is performed non-periodically.

In one embodiment, whether the first link quality evaluation is performed periodically is determined by network configuration.

In one embodiment, whether the first link quality evaluation is performed periodically is determined by the first node based on internal algorithms.

In one embodiment, the time of the behavior of performing the first link quality evaluation refers to an evaluation period.

In one embodiment, the first evaluation period is a shortest time used to execute the first link quality evaluation.

In one embodiment, a shortest evaluation time for executing the first link quality evaluation cannot be shorter than the first evaluation period.

In one embodiment, the shorter the evaluation time the easier it is to detect rapid changes in the quality of the radio link, but the evaluation results will become more volatile and the accuracy of the evaluation may be decreased, it is necessary to comprehensively consider the accuracy and evaluation speed, a DRX has a direct impact on the link quality evaluation, and a more complex and flexible DRX requires a further balance between accuracy and speed of the evaluation.

In one embodiment, the first time window set is unrelated to a running state of a DRX retransmission timer of the first MAC entity; the DRX retransmission timer of the first MAC entity is used to control a maximum time to wait for a retransmission or an authorization for a retransmission.

In one subembodiment of the embodiment, the meaning of the phrase that the first time window set is unrelated to a running state of a DRX retransmission timer of the first MAC entity comprises: within a time window of the first time window set, a DRX retransmission timer of the first MAC entity can be in either a running state or a stopped state.

In one subembodiment of the embodiment, the meaning of the phrase that the first time window set is unrelated to a running state of a DRX retransmission timer of the first MAC entity comprises: within some time windows of the first time window set, a DRX retransmission timer of the first MAC entity is in a running state; within other time windows of the first time window set, a DRX retransmission timer of the first MAC entity is in stopped state.

In one subembodiment of the embodiment, the meaning of the phrase that the first time window set is unrelated to a running state of a DRX retransmission timer of the first MAC entity comprises: a running state of a DRX retransmission timer of the first MAC entity is not used to determine any time window in the first time window set.

In one subembodiment of the above embodiment, a DRX retransmission timer of the first MAC entity is a DRX retransmission timer of a DRX group corresponding to the first cell group.

In one subembodiment of the above embodiment, a DRX retransmission timer of the first MAC entity is a DRX retransmission timer corresponding to any HARQ process of the first MAC entity.

In one subembodiment of the above embodiment, a DRX retransmission timer of the first MAC entity comprises a timer for an uplink or downlink retransmission.

In one subembodiment of the above embodiment, names of a DRX retransmission timer of the first MAC entity comprise drx and retransmission.

In one subembodiment of the above embodiment, a DRX retransmission timer for the first MAC entity comprises drx-RetransmissionTimerDL.

In one subembodiment of the above embodiment, a DRX retransmission timer for the first MAC entity comprises drx-RetransmissionTimerUL.

In one subembodiment of the above embodiment, a DRX retransmission timer of the first MAC entity is in stopped state in partial time of at least time window comprised in the first time window set.

In one embodiment, the first time window set is unrelated to a running state of a DRX inactive timer of the first MAC entity.

In one embodiment, the DRX inactive timer of the first MAC entity is drx-inactivitytimer.

In one embodiment, a name of the DRX inactive timer of the first MAC entity comprises inactivity.

In one embodiment, when a DRX group corresponding to the first cell group is activated, and the physical downlink control channel (PDCCH) indicates a new transmission of a cell belonging to a DRX group corresponding to the first cell group, a DRX inactive timer of the first MAC entity is started or restarted.

In one embodiment, an active time of a DRX group corresponding to the first cell group comprises a time when the DRX inactive timer of the first MAC entity is running.

In one embodiment, the function of a DRX inactive timer is to leave an active state after a period of inactivity, which can avoid missing continuous data.

In one embodiment, the first time length set is used to determine the second time length.

In one embodiment, the first time length set comprises multiple time lengths.

In one embodiment, the second signaling does not comprise the second time length.

In one embodiment, the meaning of the phrase that the first time length set is used to determine the second time length is: the second time length is an extreme value of a time length comprised in the first time length set; the first time length set comprises multiple time lengths.

In one embodiment, the second time length is an extreme value of a time length comprised in the first time length set being a maximum value.

In one embodiment, the second time length is an extreme value of a time length comprised in the first time length set being a minimum value.

In one embodiment, the second time length is a minimum value of a first-type DRX cycle of all DRX groups in the first cell group.

In one subembodiment of the embodiment, the first-type DRX cycle is a long-DRX cycle.

In one embodiment, a DRX group of the first cell group is a DRX group corresponding to the first cell group.

In one embodiment, a DRX of the first cell group configured by the first signaling is a long DRX.

In one embodiment, the meaning of the phrase that the first time length set is used to determine the second time length is: the second time length is an average value of time lengths comprised in the first time length set; the first time length set comprises multiple time lengths.

In one embodiment, the meaning of the phrase that the second time length is an average value of time lengths comprised in the first time length set is a maximum value is: the second time length is an arithmetic average value of time lengths comprised in the first time length set.

In one embodiment, the meaning of the phrase that the second time length is an average value of time lengths comprised in the first time length set is a maximum value is: the second time length is a weighted average value of time lengths comprised in the first time length set.

In one embodiment, the meaning of the phrase that the second time length is an average value of time lengths comprised in the first time length set is a maximum value is: the second time length is a median average value of time lengths comprised in the first time length set.

In one embodiment, the second time length is any time length in the first time length set.

In one embodiment, the second time length is any time length other than the first time length in the first time length set.

In one embodiment, the first signaling comprises the second time length.

In one embodiment, the first signaling indicates the second time length.

In one subembodiment of the embodiment, the first signaling indicates from multiple DRX configurations a DRX cycle comprised in which configuration is the second time length.

In one subembodiment of the embodiment, the first signaling indicates from multiple DRX group configurations a DRX period comprised in which configuration is the second time length.

In one embodiment, the first signaling indicates at least one coefficient used to determine the second time length.

In one embodiment, the second time length belongs to the first time length set.

In one embodiment, the second time length does not belong to the first time length set.

In one embodiment, the first time length set only comprises the first time length.

In one embodiment, the first time length set only comprises the time length of the first time length.

In one embodiment, the first time length set only comprises the element of the first time length.

In one embodiment, a number of DRX(s) configured by the first parameter set is K, where K is a positive integer greater than 1; the first time length and K are used together to determine the second time length.

In one embodiment, the meaning of the phrase that a number of DRX(s) configured by the first parameter set is K is or comprises: the first parameter set comprises a DRX configuration list, the DRX configuration list comprises K DRX configurations, and each of the K DRX configurations comprises a DRX cycle.

In one embodiment, the meaning of the phrase that a number of DRX(s) configured by the first parameter set is K is or comprises: the first parameter set comprises K DRX configurations, each DRX cycle in the K DRX configurations belongs to the first time length set, and the first time length set comprises K time lengths.

In one embodiment, any time window within the first time window set corresponds to a running of a first-type DRX timer; a name of the first-type DRX timer comprises onduration.

In one embodiment, the first-type DRX timer is a DRX onduration timer.

In one embodiment, each running of the first-type DRX timer is a start of a DRX cycle.

In one embodiment, an active time of the first MAC entity comprises a running time of the first-type DRX timer.

In one embodiment, the K DRX configurations correspond to K first-type DRX timers.

In one subembodiment of the embodiment, a time interval between two successive runnnings of any of the K first-type DRX timers corresponding to the K DRX configurations is a DRX cycle.

In one subembodiment of the embodiment, a shortest time interval in a time interval between two successive runnnings of any of the K first-type DRX timers corresponding to the K DRX configurations is a DRX cycle.

In one embodiment, the K first-type DRX timers corresponding to the K DRX configurations belong to a same DRX group.

In one embodiment, the K first-type DRX timers corresponding to the K DRX configurations are all for the first MAC entity.

In one embodiment, the K first-type DRX timers corresponding to the K DRX configurations are all for the first cell group.

In one embodiment, the K DRXs configured in the first parameter set belong to a same DRX group.

In one embodiment, the K DRXs configured by the first parameter set respectively belong to K DRX groups.

In one embodiment, the first parameter set is configured with K DRX groups in the first cell group, and each DRX group in the K DRX groups comprises a DRX cycle belonging to the first time length set; correspondingly, the first time length set comprises K time lengths.

In one embodiment, any of the K DRX groups configured for the first cell group by the first parameter set comprises the first-type DRX timer; a time interval between two successive runnings of a first-type DRX timer comprised in any of the K DRX groups for the first cell group configured by the first parameter set is a DRX cycle.

In one embodiment, any of the K DRX groups configured for the first cell group by the first parameter set comprises the first-type DRX timer; a shortest time interval in a time interval between two successive runnings of a first-type DRX timer comprised in any of the K DRX groups configured for the first cell group by the first parameter set is a DRX cycle.

In one embodiment, the meaning of the phrase that a system frame number, a subframe number and the first time length set are used together to determine a first time window set comprises: a system frame number, a subframe frame number, and a first time length set are used together to determine a first time window in the first time window set; the first offset set comprises a second offset, and the second offset is a time offset of a second time window relative to the first time window; the second time window belongs to the first time window, and the second offset is not 0; a first time window corresponds to a running time of an onduration timer of a DRX of the first MAC entity, and the onduration timer of the DRX of the first MAC entity only runs at a start of a DRX cycle.

In one embodiment, the first time length set only comprises the first time length; any DRX cycle determined by the first time length comprises K time windows in the first time window set, and the first time length and K are used together to determine the second time length.

In one subembodiment of the embodiment, the first time length set only comprises the time length of the first time length.

In one subembodiment of the embodiment, the first time length set only comprises the element of the first time length.

In one subembodiment of the embodiment, the K time windows in the first time window set comprised in any DRX cycle determined by the first time length are continuous K time windows.

In one subembodiment of the embodiment, a typical time length in the first time window set is 50 ms.

In one embodiment, only one of the K time windows in the first time window set comprised in any DRX cycle determined by the first time length corresponds to a running of a first-type DRX timer, and a name of the first-type DRX timer comprises Onduration; within a time window other than the only one of the K time windows in the first time window set comprised in any DRX cycle determined by the first time length, the first type DRX timer is not running.

In one embodiment, a running time of a second-type DRX timer corresponds to, a time window other than the only one of the K time windows in the first time window set comprised in any DRX cycle determined by the first time length.

In one embodiment, a time window other than the only one of the K time windows in the first time window set comprised in any DRX cycle determined by the first time length does not correspond to a running of any DRX timer.

In one embodiment, the meaning of the phrase that a target DRX cycle is used to determine the first evaluation period comprises: the target DRX cycle and a first coefficient are used together to determine the first evaluation period, when a time interval between any two adjacent time windows in the first time window set is equal, the first coefficient is equal to 1; when a time interval between any two adjacent time windows in the first time window set is a candidate time interval in a first candidate time interval set and the first candidate time interval set comprises at least a first time interval and a second time interval, the first coefficient is not equal to 1.

In one embodiment, the first candidate time interval set also comprises a time interval other than the first time interval and the second time interval.

In one embodiment, the first candidate time interval set only comprises the first time interval and the second time interval.

In one embodiment, the first candidate time interval set is configurable.

In one embodiment, when the first coefficient is not equal to 1, the first coefficient is equal to K, where K is a number of element(s) in the first time length set.

In one embodiment, when the first coefficient is not equal to 1, the first coefficient is equal to 1/K, where K is a number of element(s) in the first time length set.

In one embodiment, when the first coefficient is not equal to 1, the first coefficient is equal to K+1, where K is a number of element(s) in the first time length set.

In one embodiment, when the first coefficient is not equal to 1, the first coefficient is equal to 1/(K+1), where K is a number of element(s) in the first time length set.

In one embodiment, when the first coefficient is not equal to 1, the first coefficient is equal to K, where K is a number of DRX group(s) corresponding to the first cell group.

In one embodiment, when the first coefficient is not equal to 1, the first coefficient is equal to 1/K, where K is a number of DRX group(s) corresponding to the first cell group.

In one embodiment, when the first coefficient is not equal to 1, the first coefficient is equal to K, where K is a number of DRX configuration(s) of the first MAC entity configured by the first parameter set.

In one embodiment, when the first coefficient is not equal to 1, the first coefficient is equal to 1/K, where K is a number of DRX configuration(s) of the first MAC entity configured by the first parameter set.

In one embodiment, when the first coefficient is not equal to 1, the first coefficient is equal to K+1, where K is a number of DRX group(s) corresponding to the first cell group.

In one embodiment, when the first coefficient is not equal to 1, the first coefficient is equal to 1/(K+1), where K is a number of DRX group(s) corresponding to the first cell group.

In one embodiment, when the first coefficient is not equal to 1, the first coefficient is equal to K+1, where K is a number of DRX configuration(s) of the first MAC entity configured by the first parameter set.

In one embodiment, when the first coefficient is not equal to 1, the first coefficient is equal to 1/(K+1), where K is a number of DRX configuration(s) of the first MAC entity configured by the first parameter set.

In one embodiment, a first indication interval is a minimum interval between two adjacent evaluation results of the first link quality evaluation indicated by a physical layer of the first node to a higher layer.

In one embodiment, the target DRX cycle is used to determine the first indication interval.

In one embodiment, the meaning of the phrase that a first indication interval is a minimum interval between two adjacent evaluation results of the first link quality evaluation indicated by a physical layer of the first node to a higher layer is: a first indication interval is a minimum interval between two adjacent evaluation results of the first link quality evaluation indicated by a physical layer of the first node to a MAC layer.

In one embodiment, the meaning of the phrase that a first indication interval is a minimum interval between two adjacent evaluation results of the first link quality evaluation indicated by a physical layer of the first node to a higher layer is: a first indication interval is a minimum interval between two adjacent evaluation results of the first link quality evaluation indicated by a physical layer of the first node to an RRC layer.

In one embodiment, a name of the first evaluation period comprises Tevaluate.

In one embodiment, the first evaluation period is Tₑᵥₐₗᵤₐₜₑ.

In one embodiment, the first evaluation period is Tₑᵥₐₗᵤₐₜₑ.

In one embodiment, the first evaluation period is T_{Evaluate_BFD_SSB}.

In one embodiment, the first evaluation period is T_{Evaluate_BFD_CSI-RS}.

In one embodiment, the first evaluation period is T_{Evaluate_CBD}.

In one embodiment, the first evaluation period is T_{Evaluate_CBD_SSB}.

In one embodiment, the first evaluation period is T_{Evaluate_CBD_CSI-RS}.

In one embodiment, the first evaluation period is T_{Evaluate_BFD_SSB_CCA}.

In one embodiment, the first evaluation period is T_{Evaluate_CBD_CSI-RS_CCA}.

In one embodiment, the first evaluation period is T_{Evaluate_out_SSB}.

In one embodiment, the first evaluation period is T_{Evaluate_in_SSB}.

In one embodiment, the first evaluation period is T_{Evaluate_in_CSI-RS}.

In one embodiment, the first evaluation period is T_{Evaluate_out_CSI-RS}.

In one embodiment, a name of the first indication interval comprises Tindication.

In one embodiment, the first indication interval is or comprises T_{Indication_interval}.

In one embodiment, the first indication interval is or comprises T_{Indication_interval_BFD_CCA}.

In one embodiment, the first indication interval is or comprises T_{Indication_interval,CCA}. In one embodiment, the first indication interval is or comprises T_{Indication_interval_BFD}.

In one embodiment, the first node is not configured to monitor a DCI with CRC scrambled by PS-RNTI (DCP).

In one embodiment, the first node is configured to monitor a DCP, and the DCP indicates starting the first-type DRX timer.

In one embodiment, the first node is configured to monitor a DCP, and the DCP indicates starting a drx-onDurationTimer timer.

In one embodiment, the method proposed in the present application is applicable to Clean Channel Assessment (CCA).

In one embodiment, the first link quality evaluation comprises cell identification.

In one subembodiment of the above embodiment, the first evaluation period is a period for cell identification.

In one embodiment, the first link quality evaluation comprises a primary synchronization signal (PSS)/secondary synchronization signal (SSS) detection.

In one subembodiment of the above embodiment, the first evaluation period is a period of PSS/SSS detection.

In one embodiment, the first link quality evaluation comprises intra-frequency measurements.

In one subembodiment of the above embodiment, the first evaluation period is a measurement period for intra-frequency measurements.

In one embodiment, the first link quality evaluation comprises inter-frequency measurements.

In one subembodiment of the above embodiment, the first evaluation period is a measurement period for inter-frequency measurements.

In one embodiment, the first link quality evaluation comprises an L1 RSRP measurement.

In one subembodiment of the above embodiment, the first evaluation period is a period of an L1 RSRP reporting.

In one embodiment, the first link quality evaluation comprises a sounding reference signal (SRS)-RSRP measurement.

In one subembodiment of the above embodiment, the first evaluation period is a period measured by SRS-RSRP.

In one embodiment, the first link quality evaluation comprises a sidelink synchronization signal evaluation.

In one subembodiment of the above embodiment, the first evaluation period is a period evaluated by a sidelink synchronization signal.

In one embodiment, the first-type DRX cycle is a long DRX cycle.

In one embodiment, a long DRX cycle corresponds to a long DRX.

In one embodiment, a short DRX cycle corresponds to a short DRX.

In one embodiment, the first-type DRX cycle is a type of DRX cycle other than a long DRX cycle and a short DRX cycle.

In one embodiment, the first parameter set comprises a configuration of a long DRX cycle, the first-type DRX cycle is a DRX cycle other than a long DRX cycle, and the target DRX cycle is a long DRX cycle comprised in the first parameter set.

In one embodiment, the first time length is used to determine the target DRX cycle.

In one embodiment, the target DRX cycle is linearly correlated with the first time length.

In one embodiment, the target DRX cycle satisfies (k+n)*T, where T represents the first time length; both k and n represent coefficients.

In one subembodiment of the above embodiment, k is a number of offset(s) in the first offset set.

In one subembodiment of the above embodiment, k is a number of DRX(s) of the first cell group configured by the first signaling.

In one subembodiment of the above embodiment, k is a number of DRX group(s) of the first cell group configured by the first signaling.

In one subembodiment of the above embodiment, n is a coefficient.

In one subembodiment of the above embodiment, n is equal to one of −1, 1, 0, −2 and 2.

In one embodiment, the target DRX cycle satisfies an approximate value of 1/(k+n)*T or 1/(k+n)*T, where T represents the first time length; both k and n represent coefficients.

In one subembodiment of the above embodiment, k is a number of DRX(s) of the first cell group configured by the first signaling.

In one subembodiment of the above embodiment, K is a number of offset(s) in the first offset set.

In one subembodiment of the above embodiment, k is a number of DRX group(s) of the first cell group configured by the first signaling.

In one subembodiment of the above embodiment, n is a coefficient.

In one subembodiment of the above embodiment, n is equal to one of −1, 1, 0, −2 and 2.

In one embodiment, an approximate value in the present application refers to an approximate value of one decimal place.

In one embodiment, an approximate value in the present application refers to an approximate value of two decimal place.

In one embodiment, an approximate value in the present application refers to an approximate value of three decimal place.

In one embodiment, the target DRX cycle satisfies 0.5*T, where T represents the first time length.

In one embodiment, the target DRX cycle satisfies 0.75*T, where T represents the first time length.

In one embodiment, the behavior of executing a first link quality evaluation is or comprises: executing a link quality evaluation on a first reference signal resource set during a first evaluation period.

In one embodiment, when a result of the first link quality evaluation is less than a first threshold, a physical layer of the first node transmits a first-type indication to a higher layer.

In one embodiment, the first link quality evaluation is conducted within an evaluation period.

In one embodiment, the first link quality evaluation is an evaluation or estimation of reception quality for the first reference signal resource set.

In one embodiment, the meaning of the phrase that a time of the behavior of executing a first link quality evaluation is a first evaluation period comprises: the first node should be able to evaluate within the first evaluation period that downlink quality estimated by the first reference signal resource set during a latest period determined by the first evaluation period is lower than the first threshold.

In one embodiment, an active time of the first MAC entity comprises an active time of any DRX group in the first cell.

In one embodiment, an active time of the first MAC entity is an active time of all DRX groups in the first cell.

In one embodiment, any serving cell can belong to multiple DRX groups or DRX subgroups of the first cell group.

In one embodiment, any serving cell of the first cell group can belong to multiple DRX groups or DRX subgroups of the first cell group configured by the first signaling.

In one embodiment, a DRX configured by the first signaling comprises an extra DRX.

In one embodiment, a DRX configured by the first signaling comprises a DRX for traffic.

In one embodiment, a DRX configured by the first signaling is not a traditional DRX.

In one embodiment, the DRX configured by the first signaling is not a sidelink DRX.

In one embodiment, the DRX configured by the first signaling is not a DRX for broadcast or multicast.

In one embodiment, an active time of the first MAC entity is an active time of a DRX group corresponding to the first cell group.

In one embodiment, an active time of the first MAC entity comprises an active time of all DRX groups corresponding to the first cell group.

In one embodiment, an active time of the first MAC entity is a time when the first node needs to monitor a PDCCH for a C-RNTI.

In one embodiment, an active time of the first MAC entity is a time when the first node needs to monitor a PDCCH to attempt to receive downlink control information (DCI) used for uplink resource allocation.

In one embodiment, an active time of the first MAC entity is a time when the first node needs to monitor a PDCCH to attempt to receive a DCI used for downlink scheduling.

In one embodiment, an active time of the first MAC entity is a time when the first node is awake.

In one embodiment, the first node does not need to monitor a PDCCH for a C-RNTI in a time other than an active time of the first MAC entity.

In one embodiment, the first node does not need to monitor a PDCCH in a time other than an active time of the first MAC entity to attempt to receive a DCI used for uplink resource allocation.

In one embodiment, the first node does not need to monitor a PDCCH in a time other than an active time of the first MAC entity to attempt to receive a DCI used for a downlink scheduling.

### Embodiment 2

Embodiment 2 illustrates a schematic diagram of a network architecture according to the present application, as shown in FIG. 2.

FIG. 2 illustrates a network architecture 200 of 5G NR, Long-Term Evolution (LTE) and Long-Term Evolution Advanced (LTE-A) systems. The 5G NR or LTE network architecture 200 may be called a 5G System (5GS)/Evolved Packet System (EPS) 200 or other appropriate terms. The 5GS/EPS 200 may comprise one or more UEs 201, an NG-RAN 202, a 5G Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMES/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the first node in the present application is a UE 201.

In one embodiment, a base station of the second node in the present application is a gNB 203.

In one embodiment, a radio link between the UE 201 and NR node B is an uplink.

In one embodiment, a radio link between NR node B and UE 201 is a downlink.

In one embodiment, the UE 201 supports relay transmission.

In one embodiment, the UE 201 comprises a mobile phone.

In one embodiment, the UE 201 is a vehicle comprising a car.

In one embodiment, the UE 201 supports sidelink communications.

In one embodiment, the UE 201 supports MBS transmission.

In one embodiment, the UE 201 supports MBMS transmission.

In one embodiment, the gNB 203 is a MarcoCellular base station.

In one embodiment, the gNB 203 is a Micro Cell base station.

In one embodiment, the gNB 203 is a PicoCell base station.

In one embodiment, the gNB 203 is a flight platform.

In one embodiment, the gNB 203 is satellite equipment.

### Embodiment 3

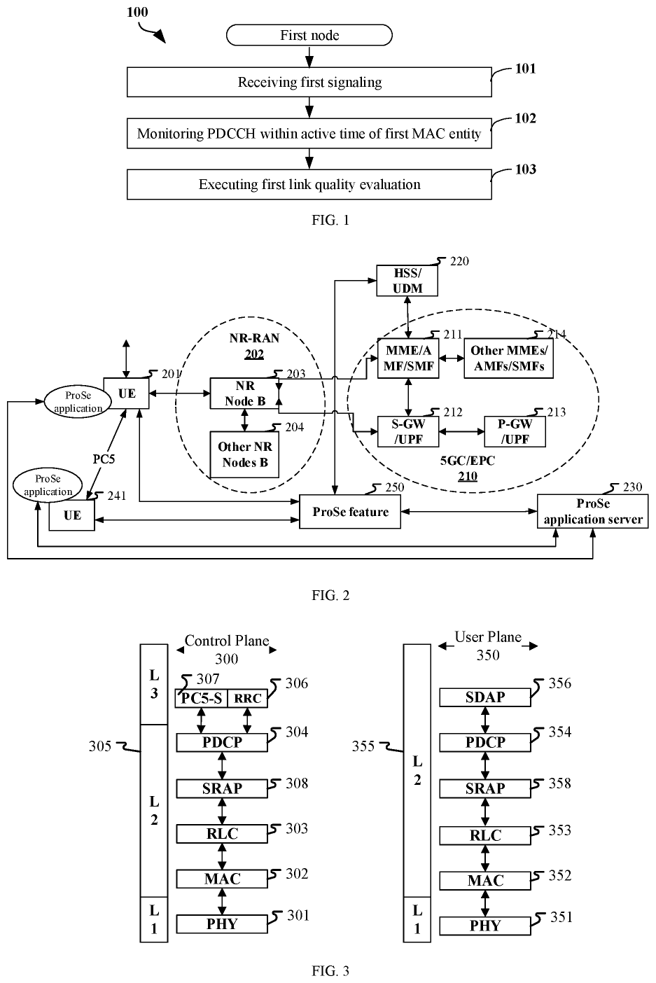

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first node (UE, gNB or a satellite or an aircraft in NTN) and a second node (gNB, UE or a satellite or an aircraft in NTN), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first node and a second node, as well as two UEs via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second node. The PDCP sublayer 304 provides multiplexing among variable radio bearers and logical channels. The PDCP sublayer 304 provides security by encrypting a packet and provides support for a first node handover between second nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. The Radio Resource Control (RRC) sublayer 306 in layer 3(L3) of the control plane 300 is responsible for acquiring radio resources (i.e., radio bearer) and configuring the lower layer with an RRC signaling between a second node and a first node. PC5 Signaling Protocol (PC5-S) sublayer 307 is responsible for the processing of signaling protocol at PC5 interface. The radio protocol architecture of the user plane 350 comprises layer 1 (L1) and layer 2 (L2). In the user plane 350, the radio protocol architecture for the first node and the second node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. SRB can be seen as a service or interface provided by the PDCP layer to a higher layer, such as the RRC layer. In NR system, SRB comprises SRB1, SRB2, SRB3, and when it comes to sidelink communications, there is also SRB4, which is respectively used to transmit different types of control signalings SRB, a bearer between a UE and access network, is used to transmit a control signaling, comprising an RRC signaling, between UE and access network. SRB1 has special significance for a UE. After each UE establishes an RRC connection, there will be SRB1 used to transmit RRC signaling Most of the signalings are transmitted through SRB1. If SRB1 is interrupted or unavailable, the UE must perform RRC reconstruction. SRB2 is generally used only to transmit an NAS signaling or signaling related to security aspects. UE cannot configure SRB3. Except for emergency services, a UE must establish an RRC connection with the network for subsequent communications. Although not described in the figure, the first node may comprise several higher layers above the L2 305. also comprises a network layer (i.e., IP layer) terminated at a P-GW 213 of the network side and an application layer terminated at the other side of the connection (i.e., a peer UE, a server, etc.). For UE involving relay service, its control plane can also comprise the adaptation sub-layer Sidelink Relay Adaptation Protocol (SRAP) 308, and its user plane can also comprise the adaptation sub-layer SRAP358, the introduction of the adaptation layer helps lower layers, such as MAC layer, RLC layer, to multiplex and/or distinguish data from multiple source UEs. For nodes that do not involve relay communications, PC5-S307, SRAP308 and SRAP358 are not required in the communication process.

In one embodiment, the radio protocol architecture in FIG. 3 is applicable to the first node in the present application.

In one embodiment, the radio protocol architecture in FIG. 3 is applicable to the second node in the present application.

In one embodiment, the first signaling in the present application is generated in the RRC 306 or the MAC 302.

In one embodiment, the first message in the present application is generated by the RRC 306.

In one embodiment, the first QoS information in the present application is generated by the RRC 306 or NAS.

### Embodiment 4

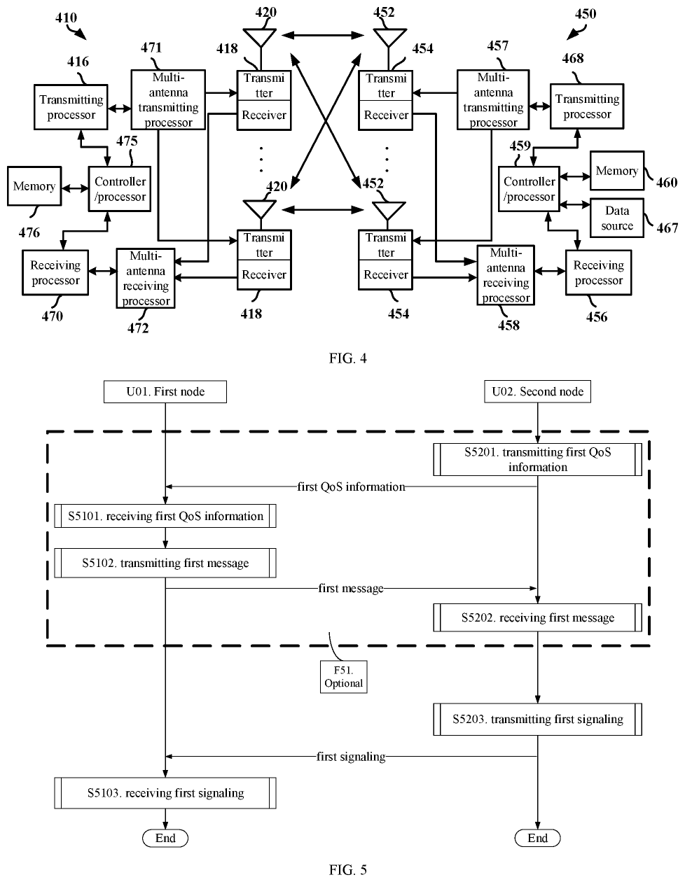

Embodiment 4 illustrates a schematic diagram of a first communication device and a second communication device according to one embodiment of the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, optionally may also comprise a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, optional can also comprise a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: receives a first signaling, the first signaling comprises a first parameter set, the first parameter set is used to configure a DRX of a first cell group; the DRX configured by the first parameter set is for a first MAC entity; within an active time of the first MAC entity, monitors a PDCCH; executes a first link quality evaluation, a time of the behavior of executing a first link quality evaluation is a first evaluation period; herein, the first parameter set comprises a first time length set, and the first time length set comprises at least a first time length; any time length in the first time length set is a first-type DRX cycle; a system frame number, a subframe number, and the first time length set are used together to determine a first time window set; the active time of the first MAC entity comprises the first time window set; a target DRX cycle is used to determine the first evaluation period; the target DRX cycle is related to whether a time interval between any two adjacent time windows in the first time window set is equal; when a time interval between any two adjacent time windows in the first time window set is equal, the target DRX cycle is equal to the first time length; when a time interval between any two adjacent time windows in the first time window set is a candidate time interval in a first candidate time interval set and the first candidate time interval set comprises at least a first time interval and a second time interval, the target DRX cycle is equal to a second time length; the first time length is not equal to the second time length; a DRX configured by the first parameter set is unrelated to PTM.

In one embodiment, the first communication device 450 comprises at least one processor and at least one memory. a memory that stores a computer readable instruction program. The computer readable instruction program generates an action when executed by at least one processor. The action includes: receiving a first signaling, the first signaling comprising a first parameter set, the first parameter set being used to configure a DRX of a first cell group; the DRX configured by the first parameter set being for a first MAC entity; within an active time of the first MAC entity, monitoring a PDCCH; executing a first link quality evaluation, a time of the behavior of executing a first link quality evaluation being a first evaluation period; herein, the first parameter set comprises a first time length set, and the first time length set comprises at least a first time length; any time length in the first time length set is a first-type DRX cycle; a system frame number, a subframe number, and the first time length set are used together to determine a first time window set; the active time of the first MAC entity comprises the first time window set; a target DRX cycle is used to determine the first evaluation period; the target DRX cycle is related to whether a time interval between any two adjacent time windows in the first time window set is equal; when a time interval between any two adjacent time windows in the first time window set is equal, the target DRX cycle is equal to the first time length; when a time interval between any two adjacent time windows in the first time window set is a candidate time interval in a first candidate time interval set and the first candidate time interval set comprises at least a first time interval and a second time interval, the target DRX cycle is equal to a second time length; the first time length is not equal to the second time length; a DRX configured by the first parameter set is unrelated to PTM.

In one embodiment, the first communication device 450 corresponds to a first node in the present application.

In one embodiment, the second communication device 410 corresponds to a second node in the present application.

In one embodiment, the first communication device 450 is a UE.

In one embodiment, the first communication device 450 is a vehicle terminal.

In one embodiment, the second communication device 450 is a relay.

In one embodiment, the second communication device 410 is a satellite.

In one embodiment, the second communication device 410 is an aircraft.

In one embodiment, the second communication device 410 is a base station.

In one embodiment, the receiver 454 (comprising the antenna 452), the receiving processor 456 and the controller/processor 459 are used to receive the first signaling in the present application.

In one embodiment, the receiver 454 (comprising the antenna 452), the receiving processor 456 and the controller/processor 459 are used to receive the first QoS information in the present application.

In one embodiment, the transmitter 454 (comprising antenna 452), the transmitting processor 468 and the controller/processor 459 are used to transmit the first message in the present application.

### Embodiment 5

Embodiment 5 illustrates a flowchart of radio signal transmission according to one embodiment in the present application, as shown in FIG. 5. In FIG. 5, U01 corresponds to a first node in the present application, U02 corresponds to a second node in the present application. It is particularly underlined that the order illustrated in the embodiment does not put constraints over sequences of signal transmissions and implementations and steps in F51 are optional.

The first node U01 receives first QoS information in step S5101; transmits a first message in step S5102; receives a first signaling in step S5103;

The second node U02 transmits first QoS information in step S5201; receives a first message in step S5202; transmits a first signaling in step S5203;

In embodiment 5, the first signaling comprises a first parameter set, the first parameter set is used to configure a DRX of a first cell group; the DRX configured by the first parameter set is for a first MAC entity;
the first node U01, within an active time of the first MAC entity, monitors a PDCCH;
the first node U01 executes a first link quality evaluation, a time of the behavior of executing a first link quality evaluation is a first evaluation period;
herein, the first parameter set comprises a first time length set, and the first time length set comprises at least a first time length; any time length in the first time length set is a first-type DRX cycle; a system frame number, a subframe number, and the first time length set are used together to determine a first time window set; the active time of the first MAC entity comprises the first time window set; a target DRX cycle is used to determine the first evaluation period; the target DRX cycle is related to whether a time interval between any two adjacent time windows in the first time window set is equal; when a time interval between any two adjacent time windows in the first time window set is equal, the target DRX cycle is equal to the first time length; when a time interval between any two adjacent time windows in the first time window set is a candidate time interval in a first candidate time interval set and the first candidate time interval set comprises at least a first time interval and a second time interval, the target DRX cycle is equal to a second time length; the first time length is not equal to the second time length; a DRX configured by the first parameter set is unrelated to PTM.

In one embodiment, the first node U01 is a UE, the second node U02 is a serving cell or a cell group of the first node U01.

In one embodiment, the first node U01 is a UE, and the second node U02 is a base station serving the first node U01.

In one embodiment, the first node U01 transmits the first message through uplink.

In one embodiment, the first node transmits the first signaling through downlink.

In one embodiment, the second node U02 is the first cell group.

In one embodiment, the second node U02 is a serving cell in the first cell group.

In one embodiment, the second node U02 is an MN of the first cell group.

In one embodiment, the first QoS information is used to indicate at least one of the first time interval, the second time interval or the first time length set.

In one embodiment, the first QoS information is for a first service.

In one embodiment, the first service is an interactive service.

In one embodiment, the first service is an XR traffic.

In one embodiment, the first service is a traffic with strict requirements for latency.

In one embodiment, the first service is a traffic with strict requirements for power saving.

In one embodiment, the first QoS information comprises 5QI.

In one embodiment, the first QoS information comprises a quality indication.

In one embodiment, the first QoS information comprises QoS characteristics.

In one embodiment, the first QoS information comprises reaching a time interval.

In one embodiment, the first QoS information comprises a traffic model or a traffic arrival model.

In one embodiment, the first QoS information comprises time delay requirement.

In one embodiment, the first QoS information comprises packet delay budget (PDB).

In one embodiment, the first QoS information comprises parameters of a PDU set.

In one embodiment, the first QoS information comprises arrival rate or frame rate.

In one subembodiment of the above embodiment, the arrival rate or frame rate are used to determine the first time length.

In one embodiment, the first QoS information is NAS information.

In one embodiment, the first QoS information is generated by the second node U02.

In one embodiment, the first QoS information is information generated by the NAS layer forwarded by the second node U02.

In one embodiment, the first QoS information is information generated by the application layer forwarded by the second node U02.

In one embodiment, the first QoS information triggers the first message.

In one embodiment, the first QoS information is received before the first message.

In one embodiment, first QoS information is used to indicate at least one of a first time interval, a second time interval or a first time length.

In one embodiment, the first QoS information comprises a first parameter, and the first parameter comprised in the first QoS information has a mapping relation with a set of QoS characteristics.

In one subembodiment of the above embodiment, the first parameter comprised in the first QoS information comprises 5QI.

In one embodiment, the set of QoS characteristics comprises resource type, default priority, default priority, PDB, error packet rate, default maximum data burst volume and default averaging window; a type of resource comprises Guaranteed Bit Rate (GBR) and Non-GBR; a default priority is identified by an integer, and the smaller the value, the higher the priority.

In one embodiment, the first QoS information comprises a set of QoS characteristics.

In one embodiment, the set of QoS characteristics comprises at least one QoS characteristic.

In one embodiment, the QoS characteristic is a parameter related to QoS.

In one embodiment, the set of QoS characteristics comprises: interactive latency.

In one embodiment, the set of QoS characteristics comprises: backhaul interactive delay.

In one embodiment, the set of QoS characteristics comprises: motion-to-photon latency.

In one embodiment, the set of QoS characteristics comprises: roundtrip time (RTT).

In one embodiment, the set of QoS characteristics comprises: roundtrip delay.

In one embodiment, the set of QoS characteristics comprises: maximum RTT.

In one embodiment, the set of QoS characteristics comprises: pose-to-photon latency.

In one embodiment, the set of QoS characteristics comprises: pose-to-render-to-photon time.

In one embodiment, the set of QoS characteristics comprises: backhaul delay of XR traffic.

In one embodiment, the set of QoS characteristics comprises: RTT of XR traffic.

In one embodiment, the set of QoS characteristics comprises: a delay interval.

In one embodiment, the set of QoS characteristics comprises: an interactive latency interval.

In one embodiment, the set of QoS characteristics comprises: a minimum interactive latency.

In one embodiment, the set of QoS characteristics comprises: a maximum interactive latency.

In one embodiment, the set of QoS characteristics comprises: a minimum RTT.

In one embodiment, the set of QoS characteristics comprises: a maximum RTT.

In one embodiment, the set of QoS characteristics comprises: a minimum XR time delay.

In one embodiment, the set of QoS characteristics comprises: a maximum XR time delay.

In one embodiment, parameters related to time delay comprised in the set of QoS characteristics is an average value.

In one embodiment, parameters related to time delay comprised in the set of QoS characteristics is a minimum value.

In one embodiment, parameters related to time delay comprised in the set of QoS characteristics is a maximum value.

In one embodiment, the set of QoS characteristics comprises: traffic structure.

In one embodiment, the set of QoS characteristics comprises: traffic model or traffic template.

In one embodiment, the set of QoS characteristics comprises: uplink packet delay budget (PDB) and downlink PDB.

In one subembodiment of the embodiment, a sum of an uplink PDB and a downlink PDB is an interactive backhaul delay.

In one embodiment, the set of QoS characteristics comprises: pose-to-response time interval or time delay.

In one embodiment, the set of QoS characteristics comprises: time delay requirement.

In one embodiment, the set of QoS characteristics comprises: time delay jitter.

In one embodiment, the set of QoS characteristics comprises: response time.

In one embodiment, parameters related to a time delay comprised in the first QoS information are the first time offset.

In one embodiment, parameters related to an interactive time delay comprised in the first QoS information are the first time offset.

In one embodiment, parameters related to RTT comprised in the first QoS information are the first time offset.

In one embodiment, parameters related to a time delay comprised in the first QoS information are approximated or rounded to a specific value to be equal to the first time offset.

In one embodiment, parameters related to an interactive time delay comprised in the first QoS information are approximated or rounded to a specific value to be equal to the first time offset.

In one embodiment, parameters related to round trip time (RTT) comprised in the first QoS information are approximated or rounded to a specific value to be equal to the first time offset.

In one embodiment, a time-related parameter comprised in the group of QoSs is the first time interval.

In one embodiment, a group of time-related parameters comprised in the group of QoSs is the first time interval and the second time interval.

In one embodiment, a time delay-related parameter comprised in the group of QoSs is the first time interval.

In one embodiment, a group of time delay-related parameters comprised in the group of QoSs is the first time interval and the second time interval.

In one embodiment, an arrival time-related parameter comprised in the group of QoSs is the first time interval.

In one embodiment, a group of arrival time-related parameters comprised in the group of QoSs is the first time interval and the second time interval.

In one embodiment, an offset-related parameter comprised in the group of QoSs is used to determine the second time interval.

In one embodiment, an offset-related parameter comprised in the group of QoSs is used to determine the first offset set.

In one embodiment, a parameter related to time or period comprised in the group of QoSs is used to determine the first time length.

In one embodiment, a parameter related to packet rate or period comprised in the group of QoSs is the first time length.

In one embodiment, a DRX-related parameter comprised in the group of QoSs indicates the first time interval.

In one embodiment, a DRX-related parameter comprised in the group of QoSs indicates the second time interval.

In one embodiment, a DRX-related parameter comprised in the group of QoSs indicates the first time length.

In one embodiment, the group of QoSs comprises at least one offset in the first offset set.

In one embodiment, the first message is an RRC message.

In one embodiment, the first message is a MAC CE.

In one embodiment, the first message comprises a UEAssistanceInformation.

In one embodiment, the first node U01 transmits a second message, and the second message is used to indicate at least one of the first time interval and the second time interval.

In one subembodiment of the above embodiment, the first message comprises the first QoS information, and the first QoS information is used to indicate the DRX preference.

In one subembodiment of the above embodiment, the first message comprises the first time length.

In one subembodiment of the above embodiment, the first message comprises the first candidate time interval set.

In one embodiment, the first node U01 transmits a second message, the second message is used to indicate the first time interval and the second time interval.

In one subembodiment of the above embodiment, the first message comprises the first QoS information, and the first QoS information is used to indicate the DRX preference.

In one subembodiment of the above embodiment, the first message comprises the first candidate time interval set.

In one subembodiment of the above embodiment, the first message comprises the first time length.

In one embodiment, the second message is an RRC message.

In one embodiment, the second message is a MAC CE.

In one embodiment, the second message comprises UEAssistanceInformation.

In one embodiment, the first message is or comprises the second message.

In one embodiment, the first message and the second message are two RRC messages.

In one embodiment, the first message indicates DRX preference.

In one embodiment, the first message comprises the first time length set.

In one embodiment, the first node U01, as a response to transmitting the first message, starts a first timer.

In one embodiment, the first message comprises the first time length.

In one embodiment, the first message comprises at least one offset in the first offset set.

In one embodiment, a running state of the first timer is used to determine whether DRX preference information is allowed to be transmitted.

In one embodiment, the first timer is T345.

In one embodiment, the first timer is T346.

In one embodiment, the first timer is T346a.

In one embodiment, the first timer is T346 $, where $ is one of b, c, y, and z.

In one embodiment, the first message is transmitted before the first signaling.

In one embodiment, the first message comprises the first QoS information.

In one embodiment, the first message comprises the first candidate time interval set.

In one embodiment, the first message comprises the first time interval.

In one embodiment, the first message comprises the second time interval.

In one embodiment, the first message comprises a DRX-Preference field, and the DRX-Preference field comprised in the first message is used to indicate DRX preference for at least one DRX group of the first cell group.

In one embodiment, a cellgroupconfig cell of the first signaling used to configure the first cell group comprises the first parameter set.

In one embodiment, the first signaling is or comprises cellgroupconfig used to configure the first cell group.

In one embodiment, the first message comprises a DRX-Preference field, and the DRX-Preference field comprised in the first message is used to indicate DRX preference for all DRX groups in the first cell group.

In one embodiment, the first message comprises a second field, and the second field comprised in the first message is used to indicate DRX preference for at least one DRX group of the first cell group.

In one subembodiment of the embodiment, a name of the second field of the first message comprises DRX.

In one subembodiment of the embodiment, a name of the second field of the first message comprises

Preference.

In one embodiment, the first message comprises a third field, a name of the third field comprises preferredDRX-LongCycle, and the third field comprised in the first message is used to indicate the first time length.

In one embodiment, the first message comprises the first offset set.

In one embodiment, the first message indicates at least one time window in the first time window set.

In one subembodiment of the embodiment, the first message indicates a duration of at least one time window in the first time window set.

In one subembodiment of the embodiment, the first message indicates a start of at least one time window in the first time window set.

In one subembodiment of the embodiment, the first message indicates an end of at least one time window in the first time window set.

In one embodiment, the first message comprises a template for a DRX.

In one embodiment, the first message comprises a first index, and the first index indicates a group of DRX parameters.

In one subembodiment of the embodiment, the group of DRX parameters is the first parameter set.

In one subembodiment of the embodiment, the group of DRX parameters comprises the first time length.

In one subembodiment of the embodiment, the group of DRX parameters comprises the first time interval.

In one subembodiment of the embodiment, the group of DRX parameters comprises the second time interval.

In one subembodiment of the embodiment, the group of DRX parameters comprises the first candidate time interval set.

In one subembodiment of the embodiment, the group of DRX parameters comprises the first offset set.

In one subembodiment of the embodiment, the group of DRX parameters is indicated by a message other than the first message.

In one embodiment, the meaning of the phrase that a running state of the first timer is used to determine whether DRX preference information is allowed to be transmitted comprises: when the first timer is running, the first node does not transmit DRX preference information.

In one embodiment, the meaning of the phrase that a running state of the first timer is used to determine whether DRX preference information is allowed to be transmitted comprises: when the first timer is not running, the first node can transmit DRX preference information.

In one embodiment, the meaning of the phrase that a running state of the first timer is used to determine whether DRX preference information is allowed to be transmitted comprises: when the first message is transmitted, the first timer is not running.

In one embodiment, the first message is used to trigger the first signaling.

In one embodiment, the first QoS information is used to trigger the first message.

In one embodiment, the behavior of monitoring a PDCCH during an active time of a first DRX group set comprises receiving a first DCI, the first DCI is used to schedule a first physical downlink shared channel (PDCCH), and the first PDSCH is used to bear data of the first service.

### Embodiment 6

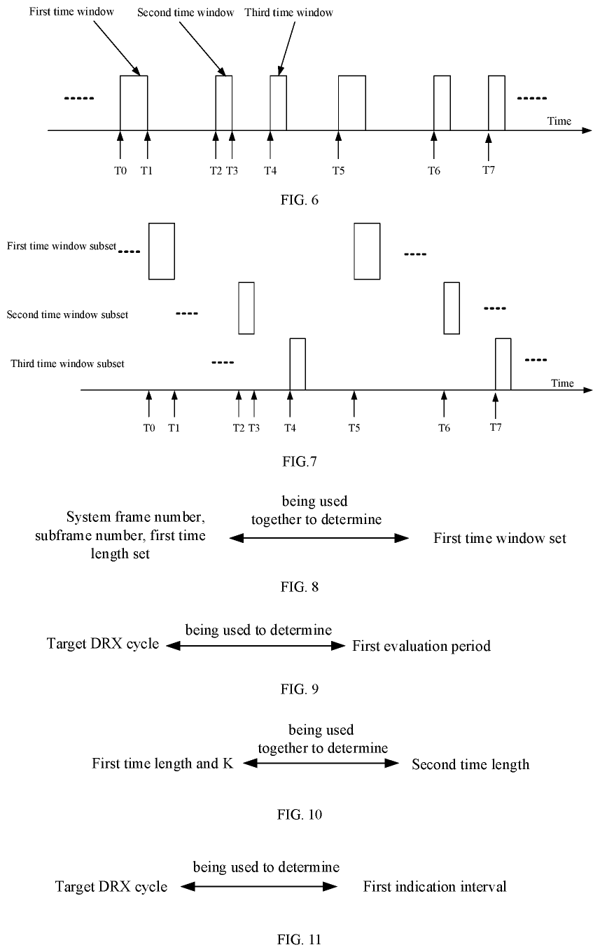

Embodiment 6 illustrates a schematic diagram of a first time window set according to one embodiment of the present application, as shown in FIG. 6.

A first time window set illustrated in FIG. 6 comprises 6 time windows. It should be noted that the methods in the present application is not limited to a number of time window(s) comprised in the first time window set, that is, a first time window set can comprise more time windows or fewer time windows, and methods in the present application are applicable. In FIGS. 6, TO, T1, . . . , T6, and T7 are respectively different times, where a start of a first time window is TO and an end is T1; a start of a second time window is T2, and an end is T3; a start of a third time window is T4; a time between T1 and T2 is equal to the first time interval, and a time between T3 and T4 is equal to the second time interval.

In one embodiment, the first message is transmitted before TO time.

In one embodiment, the first signaling is received before TO time.

In one embodiment, time from T0 to T5 is the first time length.

In one embodiment, lengths of time windows comprised in the first time window set are the same.

In one embodiment, lengths of time windows comprised in the first time window set are different.

In one embodiment, the first time window set comprises two time windows with unequal length.

In one embodiment, when a time interval between any two adjacent time windows in the first time window set is equal, a number of time window(s) belonging to any period of the first time length in the first time window set is equal to 1.

In one embodiment, a number of time windows belonging to any period of the first time length in the first time window set is greater than 1.

In one embodiment, when there exists a time interval between any two adjacent time windows in the first time window set being not equal, a number of time window(s) belonging to any period of the first time length in the first time window set is greater than 1.

In one embodiment, when a time interval between any two adjacent time windows in the first time window set is a candidate time interval in a first candidate time interval set and the first candidate time interval set comprises at least a first time interval and a second time interval, a number of time window(s) belonging to any period of the first time length in the first time window set is greater than 1.

In one embodiment, a DRX group corresponding to the first cell group is a first DRX group.

In one embodiment, the first time length is a DRX cycle of the first DRX group.

In one embodiment, the first parameter set comprises a first offset set, and the first offset set comprises K offsets.

In one subembodiment of the embodiment, when K is equal to 1, within a DRX cycle, the first time window set only comprises one time window belonging to the same DRX cycle.

In one subembodiment of the embodiment, when K is greater than 1, within a DRX cycle, the first time window set comprises K time windows belonging to the DRX cycle.

In one subembodiment of the embodiment, when K is greater than 2, within a DRX cycle, the first time window set comprises K−1 time window(s) belonging to the same DRX cycle.

In one subembodiment of the embodiment, when K is greater than 1, within a DRX cycle, the first time window set comprises K+1 time windows belonging to the same DRX cycle.

In one subembodiment of the embodiment, the first offset set comprises K offsets, the K offsets in the first offset set respectively correspond to K time windows in the first time window set, and K1-th offset in the first offset set corresponds to K1-th time window in the first time window set, K1 being a positive integer greater than 1 and not greater than K; then an K1-th offset is equal to a difference value between a start of the K1-1-th time window in the first time window set and a start of the K1-th time window in the first time window set.

In one subembodiment of the embodiment, when K is greater than 1, a length of an earliest time window within a DRX cycle in the first time window set is greater than a length of a non-earliest time window within a DRX cycle in the first time window set.

In one subembodiment of the embodiment, within a DRX cycle, an earliest one of the time windows comprised in the first time window set corresponds to a running time of a second DRX timer, the second DRX timer runs at a start of a DRX cycle, and a time interval between two successive runnings of the second DRX timer is a DRX cycle.

In one subembodiment of the embodiment, within a DRX cycle, an earliest one of the time windows comprised in the first time window set corresponds to a running time of a second DRX timer, and the second DRX timer is a drx-onDurationTimer.

In one subembodiment of the embodiment, a non-earliest one of time windows comprised in the first time window set within a DRX cycle is unrelated to whether a DRX timer is running.

In one subembodiment of the embodiment, within a DRX cycle, a non-earliest one of time windows comprised in the first time window set is unrelated to whether a DRX timer is running.

In one subembodiment of the embodiment, within a DRX cycle, a second DRX timer is not in a running state within a non-earliest one of time windows comprised in the first time window set, and the second DRX timer is a drx onDurationTimer.

In one embodiment, a number of time windows comprised in the first time window set is at least K.

In one embodiment, a number of time windows comprised in the first time window set can be more than K.

In one embodiment, time windows comprised in the first time window set are non-overlapping and discontinuous.

In one embodiment, a number of time windows comprised in the first time window set is at least K, and a number of time windows belonging to any DRX cycle in the first time window set is K.

In one subembodiment of the embodiment, a number of time windows comprised in the first time window set is more than K.

In one subembodiment of the embodiment, a number of time windows comprised in the first time window set is an integral multiple of K.

In one embodiment, the first parameter set comprises a first template used for determining the first time window set, the first template is used to indicate a first time window template set, and the first time window template set comprises more than one discontiguous time window.

In one embodiment, the first time window template set is used to generate or determine the first time window set.

In one subembodiment of the embodiment, the first time window template set shifts a specific offset in time and periodically repeated in time domain to generate the first time window set.

In one subembodiment of the embodiment, there exists a specific offset periodically repeated in time domain between a time window comprised in the first time window set and the first time window template set.

In one subembodiment of the embodiment, the first parameter set comprises a specific offset.

In one embodiment, the first time window template set and a specific offset are used together to generate or determine the first time window set.

In one embodiment, taking FIG. 6 as an example, the first time window template set comprises a first time window, a second time window, and a third time window, time T5, time T6, and time T7 are starts of three time windows of a repetition of the first time window template set in time domain, and a time interval between time TO and time T5 is the first time length.

In one embodiment, TO and T2 are spaced by 17 ms, T2 and T4 are spaced by 16 ms, and T4 and T5 are spaced by 17 ms.

In one embodiment, TO and T2 are spaced by 17 ms, T2 and T4 are spaced by 17 ms, and T4 and T5 are spaced by 16 ms.

In one embodiment, TO and T2 are spaced by 16 ms, T2 and T4 are spaced by 17 ms, and T4 and T5 are spaced by 17 ms.

In one embodiment, a time length between TO and T5 is 50 ms.

In one embodiment, a DRX cycle is a cycle during which a first time window template set repeats in time domain.

In one embodiment, each time window in a first time window template set corresponds to a running of an onduration timer of a DRX.

In one embodiment, only one time window in a first time window template set corresponds to a running of an onduration timer of a DRX.

In one embodiment, the first time window set comprises K sub-time window sets, each of the K sub-time window sets respectively correspond each of K offsets in the first offset set, and a system frame number, a subframe number, the first time length, and any offset in the first offset set are used to determine a sub-time window set corresponding to any offset in the first offset set among the K sub-time window sets; a difference value between starts of any two adjacent time windows in any of the K sub-time window sets is the first time length.

In one embodiment, the first time window set comprises K sub-time window sets, each of the K sub-time window sets respectively correspond each of K offsets in the first offset set, and a system frame number, a subframe number, the first time length, and any offset in the first offset set are used to determine a sub-time window set corresponding to any offset in the first offset set among the K sub-time window sets; starts of any two adjacent time windows in any of the K sub-time window sets are differed by the first time length.

In one embodiment, the first DRX group set comprises K DRX groups, the first time window set comprises K sub-time window sets, and starts of any two adjacent time windows in any of the K sub-time window sets are differed by the first time length; each of the K sub-time window sets respectively corresponds each of the K DRX groups in the first DRX group set.

In one embodiment, the first offset set comprises a first offset, and the first offset and an offset other than the first offset in the first offset set are offsets for different times.

In one subembodiment of the embodiment, K offsets in the first offset set correspond to the K time windows in the first time window set.

In one subembodiment of the embodiment, K offsets in the first offset set correspond to K time windows in the first time window set, for example, the K time windows in the first time window set correspond to a first time window, a second time window and a third time window in FIG. 6, when K is greater than 3, a time window later than the third time window can also be comprised.

In one subembodiment of the embodiment, K time windows in the first time window set corresponding to offsets in the first offset set belong to a same DRX cycle.

In one subembodiment of the embodiment, the first offset is drx-StartOffset.

In one subembodiment of the embodiment, the first offset corresponds to a first time window in the first time window set.

In one subembodiment of the embodiment, the first offset corresponds to a first time window in the first time window set, and the first time window is an earliest one among time windows in the first time window set corresponding to K offsets in the first offset set.

In one subembodiment of the embodiment, an offset Oi is any offset other than the first offset in the first offset set, the offset Oi corresponds to an i-th time window in the first time window set, and the offset Oi is an offset of the i-th time window relative to an i−1-th time window in the first time window set.

In one subembodiment of the embodiment, an offset Oi is any offset other than the first offset in the first offset set, the offset Oi corresponds to an i-th time window in the first time window set, and the offset Oi is an offset of the i-th time window relative to the first time window in the first time window set.

In one subembodiment of the embodiment, time windows in the first time window set are chronologically arranged in time domain, an i-th time window in the first time window set is a first time window later than an i−1-th time window, and the i-th time window is any time window in the first time window set.

In one subembodiment of the embodiment, time windows in the first time window set are chronologically arranged in time domain, and an i-th time window in the first time window set is a first one of time windows later than an i−1-th time window in the first time window set, and the i-th time window in the first time window set is any time window in the first time window set.

In one subembodiment of the embodiment, the i−1-th time window is a time window in the first time window set that is earlier than the i-th time window and adjacent to the i-th time window.

In one subembodiment of the embodiment, the meaning of the phrase that the offset Oi is an i-th time window relative to the i−1-th time window in the first time window set comprises: the offset Oi is a time interval between a start of the i-th time window and a start of an i−1-th time window in the first time window set.

In one subembodiment of the embodiment, the meaning of the phrase that the offset Oi is an i-th time window relative to the i−1-th time window in the first time window set comprises: the offset Oi is a time interval between a start of the i-th time window and an end time of an i−1-th time window in the first time window set.

In one subembodiment of the embodiment, the meaning of the phrase that the offset Oi is an i-th time window relative to the first time window in the first time window set comprises: the offset Oi is a time interval between a start of an i-th time window and a start of the first time window.

In one subembodiment of the embodiment, the meaning of the phrase that the offset Oi is an i-th time window relative to the first time window in the first time window set comprises: the offset Oi is a time interval between a start of the i-th time window and an end of the first time window.

In one subembodiment of the above embodiment, i is a positive integer greater than 1.

In one subembodiment of the above embodiment, the first offset is relative to time 0.

In one subembodiment of the above embodiment, the first offset is relative to a fixed time.

In one subembodiment of the above embodiment, the first offset is relative to an integral multiple of a subframe of the first time length.

In one subembodiment of the above embodiment, the first offset is relative to a time determined by a first offset before a start of a current DRX cycle.

In one subembodiment of the above embodiment, the first offset is relative to a modulus of X for the first time length, where X is a sum of 10 times a frame number and a subframe number.

In one subembodiment of the above embodiment, a determination of the first time window does not depend on a time window other than the first time window among the K time windows in the first time window set.

In one subembodiment of the above embodiment, a k-th time window is any time window other than the first time window among the K-th time windows in the first time window set; a determination of the k-th time window depends on at least one time window other than the k-th time window among the K-th time windows in the first time window set.

In one embodiment, the first time length set comprises multiple time lengths, the first parameter set comprises a first period, and the first period is a sum of at least two time lengths in the first time length set.

In one subembodiment of the embodiment, the first period is a sum of all time lengths in the first time length set.

In one subembodiment of the embodiment, the first period is a weighted sum of all time lengths in the first time length set.

In one subembodiment of the embodiment, the first period is a sum of weighted positive integers of all time lengths in the first time length set.

In one subembodiment of the embodiment, a time window in the first time window set comprised in the first period corresponds to a running of an onduration timer of a DRX.

In one subembodiment of the embodiment, a time window in the first time window set comprised in the first period corresponds to a running of a first-type DRX timer.

In one embodiment, the first period comprises multiple time windows in the first time window set.

In one embodiment, the first period comprises a time window defined by the first time window template set.

In one embodiment, the first period comprises a time window defined by the first time window template set adjusted by an offset.

In one embodiment, the first period corresponds to a time interval between TO and T5 in FIG. 6.

### Embodiment 7

Embodiment 7 illustrates a schematic diagram of first time window set according to one embodiment of the present application, as shown in FIG. 7.

A first time window set illustrated in FIG. 7 comprises 6 time windows. It should be noted that the methods in the present application are not limited to a number of time window(s) comprised in the first time window set, that is, a first time window set can comprise more time windows or fewer time windows, and the methods in the present application are applicable. In FIGS. 6, TO, T1, . . . , T6, and T7 are different times, where a start of the first time window is TO and an end is T1; a start of the second time window is T2, and an end is T3; a start of a third time window is T4; a time between T1 and T2 is equal to the first time interval, and a time between T3 and T4 is equal to the second time interval.

FIG. 7 illustrates that a first time window set comprises multiple subsets, such as a first time window subset, a second time window subset, and a third time window subset. The method proposed in the present application does not limit a number of subset(s) comprised in the first time window set.

In one embodiment, K2 time window subsets comprised in the first time window set respectively correspond to K2 DRX groups of the first cell group, where K2 is a positive integer greater than 1.

In one embodiment, the first time window subset corresponds to a first DRX group of the first cell group.

In one embodiment, the second time window subset corresponds to a second group of the first cell group.

In one embodiment, the third time window subset corresponds to a third DRX group of the first cell group.

In one embodiment, a number of time length(s) comprised in the first time length set is equal to K2.

In one embodiment, the first time length set only comprises the time length of the first time length.

In one embodiment, the K2 time window subsets have a definite time relation.

In one embodiment, the first parameter set comprises a relative time relation between the K2 time window subsets.

In one embodiment, the K2 DRX groups of the first cell group all use a same DRX cycle.

In one subembodiment of the embodiment, the same DRX cycle is the first time length.

In one embodiment, K2 time window subsets comprised in the first time window set respectively correspond to K2 DRX configurations in a DRX list of a first DRX group of the first cell group, where K2 is a positive integer greater than 1.

In one embodiment, the first time window subset corresponds to a first DRX configuration in a DRX list of a first DRX group of the first cell group.

In one embodiment, the second time window subset corresponds to a second DRX configuration in a DRX list of a first DRX group of the first cell group.

In one embodiment, the third time window subset corresponds to a third DRX configuration in a DRX list of a first DRX group of the first cell group.

In one embodiment, a number of time length(s) comprised in the first time length set is less than and equal to K2.

In one embodiment, the first time length set only comprises the time length of the first time length.

In one embodiment, the K2 time window subsets have a definite time relation.

In one embodiment, the first parameter set comprises a relative time relation between the K2 time window subsets.

In one embodiment, all different DRX configurations of a DRX list of a first DRX group in the first cell group apply a same DRX cycle.

In one subembodiment of the embodiment, the same DRX cycle is the first time length.

### Embodiment 8

Embodiment 8 illustrates a schematic diagram of a system frame number, a subframe number and a first time length set being used together to determine a first time window set according to one embodiment of the present application, as shown in FIG. 8.

In one embodiment, a size of any time window in the first time window set is the same.

In one embodiment, a size of a time window in the first time window set is fixed.

In one embodiment, a size of a time window in the first time window set is configurable.

In one embodiment, a size of a time window in the first time window set is configured by an RRC signaling.

In one embodiment, a size of a time window in the first time window set is configured by the first signaling.

In one embodiment, any time window in the first time window set comprises an integer number of subframe(s).

In one embodiment, a time window in the first time window set comprises a non-integral number of subframe(s).

In one embodiment, at least one time window in the first time window set comprises a non-integral number of subframe(s).

In one embodiment, the meaning of the phrase that a system frame number, a subframe number and a first time length set are used together to determine a first time window set comprises: a system frame number, a subframe number, and a first time length set are used together to determine a start of any time window in a first time window set.

In one embodiment, the meaning of the phrase that a system frame number, a subframe number and a first time length set are used together to determine a first time window set comprises: a system frame number, a subframe number, and a first time length set are used together to determine a start frame and a subframe of any time window in a first time window set.

In one embodiment, the first parameter set is used to configure a long DRX.

In one subembodiment of the embodiment, the first time length corresponds to a DRX cycle.

In one subembodiment of the embodiment, the first time length comprises an integer number of subframe(s).

In one subembodiment of the embodiment, each time determined by all system frames and subframes satisfying (SFNx*10+s) % (T)=OF corresponds to a start of a time window in the first time window set, where SFNx is system frame number, s is subframe number, OF is an offset in the first offset set, T is the first time length, and % is modulus operation.

In one embodiment, the first time window set comprises Kx sub-time window sets, and any time window in an i-th sub-time window set in the Kx sub-time window set starts at a subframe with frame number s of a system frame with frame number SFNx, then the SFNx and s satisfy (SFNx*10+s) % (T)=OFi, where T is the first time length, OFi is an i-th offset in the first offset set, and % is the modulus operation.

In one embodiment, each time determined by all system frames and subframes satisfying (SFNx*10+s) % (T)=OFi respectively corresponds to a start of a time window in an i-th sub-time window set in the first time window set, where T is a first time length, OFi is an i-th offset in the first offset set,% is the modulus operation, SFNx is system frame number, and s is subframe number; the first time window set comprises K sub-time window sets, and the i-th sub-time window set is one of the K sub-time window sets of the first time window set.

In one embodiment, the first time window set comprises Kx sub-time window sets, and any time window in an i-th sub-time window set in the Kx sub-time window set starts at a subframe with frame number s of a system frame with frame number SFNx, then the SFNx and s satisfy (SFNx*10+s) % (T)=0Fi % (T), where T is the first time length, OFi is an i-th offset in the first offset set, and % is the modulus operation.

In one embodiment, each time determined by all system frames and subframes that satisfy (SFNx*10+s) % (T)=0Fi % (T) respectively corresponds to a start of a time window in an i-th sub-time window set in the first time window set, where T is a first time length, OFi is an i-th offset in the first offset set, % is the modulus operation, SFNx is system frame number, and s is subframe number; the first time window set comprises Kx sub-time window sets, and the i-th sub-time window set is one of the Kx sub-time window sets of the first time window set.

In one embodiment, the meaning of the phrase that a system frame number, a subframe number and a first time length set are used together to determine a first time window set comprises: system frame number, subframe number, a first time length, and a first offset set are used together to determine a start of any time window in a first time window set through a formula using modulus operation.

In one embodiment, each of K offsets of the first offset set respectively corresponds to K time windows in the first time window set.

In one embodiment, an i-th offset in the first offset set is used to generate an i-th time window in the first time window set, where the i-th offset in the first offset set is any offset in the first offset set.

In one embodiment, the j-th time window is a time window adjacent to the i-th time window.

In one embodiment, the j-th time window is a first one of the K time windows in the first time window set.

In one embodiment, the j-th time window is a first one of the K time windows in the first time window set.

In one embodiment, the j-th time window and the K time windows in the first time window set belong to a same DRX cycle.

In one embodiment, each time determined by all system frames and subframes satisfying f ((SFNx*10+s)) % f(T)=f (OFi) respectively corresponds to a start of a time window of an i-th sub-time window set in the first time window set, where T is a first time length, OFi is an i-th offset in the first offset set,% is the modulus operation, SFNx is any system frame number, and s is any subframe number; the first time window set comprises Kx sub-time window sets, and the i-th sub-time window set is one of the Kx sub-time window sets of the first time window set; f ( ) is a function.

In one subembodiment of the above embodiment, f ( ) is a rounding function.

In one subembodiment of the above embodiment, f ( ) is a function multiplied by N, where N is a positive integer.

In one embodiment, each time determined by all system frames and subframes satisfying f ((SFNx*10+s)) % f(T)=f(OFi) % f(T) respectively corresponds to a start of a time window of an i-th sub-time window set in the first time window set, where T is a first time length, OFi is an i-th offset in the first offset set, % is the modulus operation, SFNx is any system frame number, and s is any subframe number; the first time window set comprises Kx sub-time window sets, and the i-th sub-time window set is one of the Kx sub-time window sets of the first time window set; f ( ) is a function.

In one subembodiment of the above embodiment, f ( ) is a rounding function.

In one subembodiment of the above embodiment, f ( ) is a function multiplied by N, where N is a positive integer.

In one embodiment, each time determined by all system frames and subframes satisfying f ((SFNx*10+s) % (T))=f(OFi) respectively corresponds to a start of a time window in an i-th sub-time window set in the first time window set, where T is a first time length, OFi is an i-th offset in the first offset set, % is the modulus operation, SFNx is any system frame number, and s is any subframe number; the first time window set comprises Kx sub-time window sets, and the i-th sub-time window set is one of the Kx sub-time window sets of the first time window set; f ( ) is a function.

In one subembodiment of the above embodiment, f ( ) is a rounding function.

In one subembodiment of the above embodiment, f ( ) is a function multiplied by N, where N is a positive integer.

In one embodiment, each time determined by all system frames and subframes satisfying f((SFNx*10+s) % (T))=f(OFi % (T)) respectively corresponds to a start of a time window in an i-th sub-time window set in the first time window set, where T is a first time length, OFi is an i-th offset in the first offset set, % is the modulus operation, SFNx is any system frame number, and s is any subframe number; the first time window set comprises Kx sub-time window sets, and the i-th sub-time window set is one of the Kx sub-time window sets of the first time window set; f ( ) is a function.

In one subembodiment of the above embodiment, f ( ) is a rounding function.

In one subembodiment of the above embodiment, f ( ) is a function multiplied by N, where N is a positive integer.

In one embodiment, the rounding function comprises rounding up, rounding down, and taking a closest integer.

In one embodiment, an output of the function multiplied by N is N times an input parameter, for example, f(x)=N*x.

In one embodiment, the first time window set comprises Kx sub-time window sets, and any time window in an i-th sub-time window set in the Kx sub-time window sets starts at a subframe with frame number s of a system frame with frame number SFNx, then the SFNx and s satisfy (SFNx*10+s) % (T)=OFi, where T is any time length in the first time length set, OFi is an i-th offset in the first offset set, and % is the modulus operation.

In one embodiment, the first time window set comprises Kx sub-time window sets, and any time window in an i-th sub-time window set in the Kx sub-time window sets starts at a subframe with frame number s of a system frame with frame number SFNx, then the SFNx and s satisfy (SFNx*10+s) % (Tj)=OFi, where Tj is a j-th time length in the first time length set, OFi is an offset, and % is the modulus operation.

In one embodiment, each time determined by all system frames and subframes satisfying (SFNx*10+s) % (Ti)=OF corresponds to a start of a time window in the first time window set, where SFNx is system frame number, s is subframe number, OF is an offset, T is any time length in the first time length, and % is modulus operation.

In one subembodiment of the embodiment, the first parameter set comprises the OF.

In one embodiment, each time determined by all system frames and subframes satisfying (SFNx*10+s) % (Ti)=OF corresponds to a start of a time window in the first time window set, where SFNx is system frame number, s is subframe number, OF is an offset, Ti is an i-th time length in the first time length, and % is modulus operation.

In one subembodiment of the embodiment, the first parameter set comprises the OF.

### Embodiment 9

Embodiment 9 illustrates a schematic diagram of a target DRX cycle being used to determine a first evaluation period according to one embodiment of the present application, as shown in FIG. 9.

In one embodiment, the first evaluation period is related to T_{Evaluate}.

In one embodiment, a name of the first evaluation period comprises Tₑᵥₐₗᵤₐₜₑ.

In one embodiment, the first evaluation period is measured by ms.

In one embodiment, the first link quality evaluation is for frequency range 1 (FR1).

In one embodiment, the first link quality evaluation is for frequency range 2 (FR2).

In one embodiment, the first evaluation period is for a deactivated PSCell.

In one embodiment, the first evaluation period is for an activated PSCell.

In one embodiment, the first evaluation period is for a PCell.

In one embodiment, the first evaluation period is T_{Evaluate} in so, the first evaluation period satisfies Max(100, Ceil(7.5×P)×Max(T_{DRX},T_{SSB})), where Max ( ) is a function that takes a maximum value, Ceil ( ) is a rounding up function, T_{SSB} is a cycle of an SSB used for radio link monitoring, T_{DRX} is the target DRX cycle, and P is a coefficient related to a measurement gap.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR1.

In one embodiment, the first evaluation period is T_{Evaluate_out_SSB}, the first evaluation period satisfies Max(200, Ceil(15×P)×Max(T_{DRX},T_{SSB})), where Max ( ) is a function that takes a maximum value, Ceil ( ) is a rounding up function, T_{SSB} is a cycle of an SSB used for radio link monitoring, T_{DRX} is the target DRX cycle, and P is a coefficient related to a measurement gap.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR1.

In one embodiment, the first evaluation period is T_{Evaluate_in_SSB}, the first evaluation period satisfies Max(100, Ceil(7.5×P×N)×Max(T_{DRX},T_{SSB})), where Max ( ) is a function that takes a maximum value, Ceil ( ) is a rounding up function, T_{SSB} is a cycle of an SSB used for radio link monitoring, T_{DRX} is the target DRX cycle, and P is a coefficient related to a measurement gap.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR2.

In one subembodiment of the embodiment, N is a scaling factor.

In one subembodiment of the embodiment, a typical value of N is 8.

In one subembodiment of the embodiment, N is used to adjust a length of a measurement period, and when a high-speed state measurement is configured, N=2.

In one embodiment, the first evaluation period is T_{Evaluate_out_SSB}, the first evaluation period satisfies Max(200, Ceil(15×P×N)×Max(T_{DRX},T_{SSB})), where Max ( ) is a function that takes a maximum value, Ceil ( ) is a rounding up function, T_{SSB} is a cycle of an SSB used for radio link monitoring, T_{DRX} is the target DRX cycle, and P is a coefficient related to a measurement gap.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR2.

In one subembodiment of the embodiment, N is a scaling factor.

In one subembodiment of the embodiment, a typical value of N is 8.

In one subembodiment of the embodiment, N is used to adjust a length of a measurement period, and when a high-speed state measurement is configured, N=2.

In one embodiment, the first evaluation period is T_{Evaluate_is_SSB}, the first evaluation period satisfies Ceil(5×P)×Max(1.5×T_{DRX}, measCyclePSCell), where Max ( ) is a function that takes a maximum value, Ceil ( ) is a rounding up function, T_{DRX} is the target DRX cycle, P is a coefficient related to a measurement gap, and measCyclePSCell is a measurement period of a PSCell.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR1.

In one subembodiment of the above embodiment, a measurement period of a PSCell is configured by the network.

In one subembodiment of the above embodiment, the first evaluation period is for a deactivated PSCell.

In one embodiment, the first evaluation period is T_{Evaluate_out_SSB}, the first evaluation period satisfies Ceil(10×P)×Max(1.5×T_{DRX}, measCyclePSCell), where Max ( ) is a function that takes a maximum value, Ceil ( ) is a rounding up function, T_{DRX} is the target DRX cycle, P is a coefficient related to a measurement gap, and measCyclePSCell is a measurement period of a PSCell.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR1.

In one subembodiment of the above embodiment, the first evaluation period is for a deactivated PSCell.

In one subembodiment of the above embodiment, a measurement period of a PSCell is configured by the network.

In one embodiment, the first evaluation period is T_{Evaluate_in_SSB}, the first evaluation period satisfies Ceil(5×P×N)×Max(1.5×T_{DRX}, measCyclePSCell), where Max ( ) is a function that takes a maximum value, Ceil ( ) is a rounding up function, T_{DRX} is the target DRX cycle, P is a coefficient related to a measurement gap, and measCyclePSCell is a measurement period of a PSCell.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR2.

In one subembodiment of the above embodiment, a measurement period of a PSCell is configured by the network.

In one subembodiment of the above embodiment, the first evaluation period is for a deactivated PSCell.

In one subembodiment of the embodiment, N is a scaling factor.

In one subembodiment of the embodiment, a typical value of N is 8.

In one subembodiment of the embodiment, N is used to adjust a length of a measurement period, and when a high-speed state measurement is configured, N=2.

In one embodiment, the first evaluation period is T_{Evaluate_out_SSB}, the first evaluation period satisfies Ceil(10×P×N)×Max(1.5×T_{DRX}, measCyclePSCell), where Max ( ) is a function that takes a maximum value, Ceil ( ) is a rounding up function, T_{DRX} is the target DRX cycle, P is a coefficient related to a measurement gap, and measCyclePSCell is a measurement period of a PSCell.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR2.

In one subembodiment of the above embodiment, the first evaluation period is for a deactivated PSCell.

In one subembodiment of the above embodiment, a measurement period of a PSCell is configured by the network.

In one subembodiment of the embodiment, N is a scaling factor.

In one subembodiment of the embodiment, a typical value of N is 8.

In one subembodiment of the embodiment, N is used to adjust a length of a measurement period, and when a high-speed state measurement is configured, N=2.

In one embodiment, the first evaluation period is T_{Evaluate_out_SSB_Relax}, the first evaluation period satisfies Max(200×K3, Ceil(15×K1×P)×Max(T_{DRX},T_{SSB})), where Max Q is a function that takes a maximum value, Ceil ( ) is a rounding up function, T_{SSB} is a cycle of an SSB used for radio link monitoring, T_{DRX} is the target DRX cycle, and P is a coefficient related to a measurement gap.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR1.

In one subembodiment of the above embodiment, when Max (T_{DRX}, T_{SSB})≤40 ms, K1 is equal to 4; when 40<Max(T_{DRX},T_{SSB})≤80 ms, K1=2.

In one subembodiment of the above embodiment, if K1 is not greater than 2, K3=K1; otherwise K3=1.

In one subembodiment of the embodiment, the embodiment is applicable to the target DRX cycle being less than or equal to 80 ms.

In one embodiment, the first evaluation period is T_{Evaluate_out_SSB_Relax}, the first evaluation period satisfies Max(200×K4, Ceil(15×K2×P×N)×Max(T_{DRX},T_{SSB})), where Max ( ) is a function that takes a maximum value, Ceil ( ) is a rounding up function, T_{SSB} is a cycle of an SSB used for radio link monitoring, T_{DRX} is the target DRX cycle, and P is a coefficient related to a measurement gap.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR2.

In one subembodiment of the above embodiment, K2=2.

In one subembodiment of the above embodiment, if K2 is not greater than 2, K4=K2; otherwise K4=1.

In one subembodiment of the embodiment, the embodiment is applicable to the target DRX cycle being less than or equal to 80 ms.

In one embodiment, the first evaluation period is T_{Evaluate_in_CSI-RS}, and the first evaluation period satisfies Max (100, Ceil(1.5×Mᵢₙ×P)×Max(T_{DRX}, T_{CSI-RS})), where Max ( ) is a function that takes a maximum value, Ceil ( ) is a rounding up function, T_{CSI-RS} is a cycle of a CSI-RS used for radio link monitoring, T_{DRX} is the target DRX cycle, and P is a coefficient related to a measurement gap.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR1.

In one subembodiment of the embodiment, a candidate value of Mᵢₙ is 10.

In one embodiment, the first evaluation period is T_{Evaluate_out_CSI-RS}, and the first evaluation period satisfies Max (200, Ceil(1.5×Mₒᵤₜ×P)×Max(T_{DRX}, T_{CSI-RS})), where Max ( ) is a function that takes a maximum value, Ceil ( ) is a rounding up function, T_{CSI-RS} is a cycle of a CSI-RS used for radio link monitoring, T_{DRX} is the target DRX cycle, and P is a coefficient related to a measurement gap.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR1.

In one subembodiment of the embodiment, a candidate value of Mₒᵤₜ is 20.

In one embodiment, the first evaluation period is T_{Evaluate_is_CSI-RS}, and the first evaluation period satisfies Max (100, Ceil(1.5×Mᵢₙ×P×N)×Max (T_{DRX}, T_{CSI-RS})), where Max ( ) is a function that takes a maximum value, Ceil ( ) is a rounding up function, T_{CSI-RS} is a cycle of a CSI-RS used for radio link monitoring, T_{DRX} is the target DRX cycle, and P is a coefficient related to a measurement gap.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR2.

In one subembodiment of the embodiment, N is a scaling factor.

In one subembodiment of the embodiment, a typical value of N is 8.

In one subembodiment of the embodiment, N is used to adjust a length of a measurement period, and when a high-speed state measurement is configured, N=2.

In one subembodiment of the embodiment, a candidate value of M in is 10.

In one embodiment, the first evaluation period is T_{Evaluate_out_CSI-RS}, and the first evaluation period satisfies Max (200, Ceil(1.5×Mₒᵤₜ×P×N)×Max(T_{DRX}, T_{CSI-RS})), where Max ( ) is a function that takes a maximum value, Ceil ( ) is a rounding up function, T_{CSI-RS} is a cycle of a CSI-RS used for radio link monitoring, T_{DRX} is the target DRX cycle, and P is a coefficient related to a measurement gap.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR2.

In one subembodiment of the embodiment, N is a scaling factor.

In one subembodiment of the embodiment, a typical value of N is 8.

In one subembodiment of the embodiment, N is used to adjust a length of a measurement period, and when a high-speed state measurement is configured, N=2.

In one subembodiment of the embodiment, a candidate value of Mₒᵤₜ is 20.

In one embodiment, the first evaluation period is T_{Evaluate_is_CSI-RS}, and the first evaluation period satisfies Ceil(Mᵢₙ×P)×Max (1.5×T_{DRX}, measCyclePSCell), where Max ( ) is a function that takes a maximum value, Ceil ( ) is a rounding up function, T_{DRX} is the target DRX cycle, P is a coefficient related to a measurement gap, and measCyclePSCell is a measurement period of a PSCell.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR1.

In one subembodiment of the above embodiment, a measurement period of a PSCell is configured by the network.

In one subembodiment of the above embodiment, the first evaluation period is for a deactivated PSCell.

In one subembodiment of the embodiment, a candidate value of M in is 10.

In one embodiment, the first evaluation period is T_{Evaluate_out_CSI-RS}, and the first evaluation period satisfies Ceil(Mₒᵤₜ×)×Max (1.5×T_{DRX}, measCyclePSCell), where Max ( ) is a function that takes a maximum value, Ceil ( ) is a rounding up function, T_{DRX} is the target DRX cycle, P is a coefficient related to a measurement gap, and measCyclePSCell is a measurement period of a PSCell.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR1.

In one subembodiment of the above embodiment, the first evaluation period is for a deactivated PSCell.

In one subembodiment of the above embodiment, a measurement period of a PSCell is configured by the network.

In one subembodiment of the embodiment, a candidate value of Mₒᵤₜ is 20.

In one embodiment, the first evaluation period is T_{Evaluate_in_CSI-RS}, and the first evaluation period satisfies Ceil(Mᵢₙ×P×N)×Max (1.5×T_{DRX}, measCyclePSCell), where Max ( ) is a function that takes a maximum value, Ceil ( ) is a rounding up function, T_{DRX} is the target DRX cycle, P is a coefficient related to a measurement gap, and measCyclePSCell is a measurement period of a PSCell.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR2.

In one subembodiment of the above embodiment, a measurement period of a PSCell is configured by the network.

In one subembodiment of the above embodiment, the first evaluation period is for a deactivated PSCell.

In one subembodiment of the embodiment, N is a scaling factor.

In one subembodiment of the embodiment, a typical value of N is 8.

In one subembodiment of the embodiment, N is used to adjust a length of a measurement period, and when a high-speed state measurement is configured, N=2.

In one subembodiment of the embodiment, a candidate value of M in is 10.

In one embodiment, the first evaluation period is T_{Evaluate_out_CSI-RS}, and the first evaluation period satisfies Ceil (Mₒᵤₜ×P×N)×Max (1.5×T_{DRX}, measCyclePSCell), where Max ( ) is a function that takes a maximum value, Ceil ( ) is a rounding up function, T_{DRX} is the target DRX cycle, P is a coefficient related to a measurement gap, and measCyclePSCell is a measurement period of a PSCell.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR2.

In one subembodiment of the above embodiment, the first evaluation period is for a deactivated PSCell.

In one subembodiment of the above embodiment, a measurement period of a PSCell is configured by the network.

In one subembodiment of the embodiment, N is a scaling factor.

In one subembodiment of the embodiment, a typical value of N is 8.

In one subembodiment of the embodiment, N is used to adjust a length of a measurement period, and when a high-speed state measurement is configured, N=2.

In one subembodiment of the embodiment, a candidate value of Mₒᵤₜ is 20.

In one embodiment, the first evaluation period is T_{Evaluate_out_CSI-RS_Relax}, the first evaluation period satisfies Max(200×K3, Ceil(15×K1×Mₒᵤₜ×P)×Max(T_{DRX},T_{CSI-RS})), where Max ( ) is a function that takes a maximum value, Ceil ( ) is a rounding up function, T_{CSI-RS} is a cycle of a CSI-RS used for radio link monitoring, T_{DRX} is the target DRX cycle, and P is a coefficient related to a measurement gap.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR1.

In one subembodiment of the above embodiment, when Max (T_{DRX}, T_{CSI-RS})≤40 ms, K1 is equal to 4; when 40<Max(T_{DRX}, T_{CSI-RS})≤80 ms, K1=2.

In one subembodiment of the above embodiment, if K1 is not greater than 2, K3=K1; otherwise K3=1.

In one subembodiment of the embodiment, the embodiment is applicable to the target DRX cycle being less than or equal to 80 ms.

In one subembodiment of the embodiment, a candidate value of M out is 20.

In one embodiment, the first evaluation period is T_{Evaluate_out_CSI-RS_Relax}, the first evaluation period satisfies Max(200×K4, Ceil(15×K2×Mₒᵤₜ×P×N)×Max(T_{DRX},T_{CSI-RS})), where Max Q is a function that takes a maximum value, Ceil ( ) is a rounding up function, T_{CSI-RS} is a cycle of a CSI-RS used for radio link monitoring, T_{DRX} is the target DRX cycle, and P is a coefficient related to a measurement gap.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR2.

In one subembodiment of the above embodiment, K2=2.

In one subembodiment of the above embodiment, if K2 is not greater than 2, K4=K2; otherwise K4=1.

In one subembodiment of the embodiment, the embodiment is applicable to the target DRX cycle being less than or equal to 80 ms.

In one subembodiment of the embodiment, a candidate value of Mₒᵤₜ is 20.

In one embodiment, the first evaluation period is T_{Evaluate_BFD_SSB}, the first evaluation period satisfies Max(50, Ceil(7.5×P)×Max(T_{DRX},T_{SSB})), where Max ( ) is a function that takes a maximum value, Ceil ( ) is a rounding up function, T_{SSB} is a cycle of an SSB in q̅₀, T_{DRX} is the target DRX cycle, and P is a coefficient related to a measurement gap.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR1.

In one embodiment, the first evaluation period is T_{Evaluate_BFD_SSB}, the first evaluation period satisfies Max(50, Ceil(7.5×P×N)×Max(T_{DRX},T_{SSB})), where Max ( ) is a function that takes a maximum value, Ceil ( ) is a rounding up function, T_{SSB} is a cycle of an SSB in q̅₀, T_{DRX} is the target DRX cycle, and P is a coefficient related to a measurement gap.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR2.

In one subembodiment of the embodiment, N is a scaling factor.

In one subembodiment of the embodiment, a typical value of N is 8.

In one subembodiment of the embodiment, N is used to adjust a length of a measurement period, and when a high-speed state measurement is configured, N=2.

In one embodiment, the first evaluation period is T_{Evaluate_BFD_SSB}, the first evaluation period satisfies Max(50, Ceil(7.5×P)×Max(measCyclePscell,T_{SSB})), where Max ( ) is a function that takes a maximum value, Ceil ( ) is a rounding up function, T_{DRX} is the target DRX cycle, P is a coefficient related to a measurement gap, and measCyclePSCell is a measurement period of a PSCell.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR1.

In one subembodiment of the above embodiment, a measurement period of a PSCell is configured by the network.

In one subembodiment of the above embodiment, the first evaluation period is for a deactivated PSCell.

In one embodiment, the first evaluation period is T_{Evaluate_BFD_SSB}, the first evaluation period satisfies Max(50, Ceil(7.5×P×N)×Max(measCyclePscell,T_{SSB})), where Max ( ) is a function that takes a maximum value, Ceil ( ) is a rounding up function, T DRX is the target DRX cycle, P is a coefficient related to a measurement gap, and measCyclePSCell is a measurement period of a PSCell.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR2.

In one subembodiment of the above embodiment, a measurement period of a PSCell is configured by the network.

In one subembodiment of the above embodiment, the first evaluation period is for a deactivated PSCell.

In one subembodiment of the embodiment, N is a scaling factor.

In one subembodiment of the embodiment, a typical value of N is 8.

In one subembodiment of the embodiment, N is used to adjust a length of a measurement period, and when a high-speed state measurement is configured, N=2.

In one embodiment, the first evaluation period is T_{Evaluate_BFD_SSB_Relax}, the first evaluation period satisfies Max(50×K3, Ceil(7.5×K1×P)×Max(T_{DRX},T_{SSB})), where Max ( ) is a function that takes a maximum value, Ceil ( ) is a rounding up function, T_{SSB} is a cycle of an SSB in q̅₀, T_{DRX} is the target DRX cycle, and P is a coefficient related to a measurement gap.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR1.

In one subembodiment of the above embodiment, when Max (T_{DRX},T_{SSB})≤40 ms, K1 is equal to 4; when (T_{DRX}, T_{SSB})≤80 ms, K1=2.

In one subembodiment of the above embodiment, if K1 is not greater than 2, K3=K1; otherwise K3=1.

In one subembodiment of the embodiment, the embodiment is applicable to the target DRX cycle being less than or equal to 80 ms.

In one embodiment, the first evaluation period is T_{Evaluate_BFD_SSB_Relax}, the first evaluation period satisfies Max(50×K4, Ceil(7.5×K2×P×N)×Max(T_{DRX},T_{SSB})), where Max ( ) is a function that takes a maximum value, Ceil ( ) is a rounding up function, T_{SSB} is a cycle of an SSB in q̅₀, T_{DRX} is the target DRX cycle, and P is a coefficient related to a measurement gap.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR2.

In one subembodiment of the above embodiment, K2=2.

In one subembodiment of the above embodiment, if K2 is not greater than 2, K4=K2; otherwise K4=1.

In one subembodiment of the embodiment, the embodiment is applicable to the target DRX cycle being less than or equal to 80 ms.

In one embodiment, the first evaluation period is T_{Evaluate_BFD_CSI-RS}, and the first evaluation period satisfies Max(50, Ceil(1.5×M_{BFD}×P×P_{BFD})×Max(T_{DRX}, T_{CSI-RS})), where Max ( ) is a function that takes a maximum value, Ceil ( ) is a rounding up function, T_{CSI-RS} is a cycle of CSI-RS resources in q̅₀, T_{DRX} is the target DRX cycle, and P is a coefficient related to a measurement gap.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR1.

In one embodiment, the first evaluation period is T_{Evaluate_BFD_CSI-RS}, and the first evaluation period satisfies Max(50, Ceil(1.5×M_{BFD}×P×N×P_{BFD})×Max(T_{DRX}, T_{CSI-RS})), where Max ( ) is a function that takes a maximum value, Ceil ( ) is a rounding up function, T_{CSI-RS} is a cycle of CSI-RS resources in q̅₀, T_{DRX} is the target DRX cycle, and P is a coefficient related to a measurement gap.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR2.

In one subembodiment of the embodiment, N is a scaling factor.

In one subembodiment of the embodiment, a typical value of N is 8.

In one subembodiment of the embodiment, N is used to adjust a length of a measurement period, and when a high-speed state measurement is configured, N=2.

In one embodiment, the first evaluation period is T_{Evaluate_BFD_CSI-RS}, and the first evaluation period satisfies Max(50, Ceil(1.5×M_{BFD}×P×P_{BFD})×Max(measCyclePscell, T_{CSI-RS})), where Max ( ) is a function that takes a maximum value, Ceil ( ) is rounding up functions, T_{DRX} is the target DRX cycle, P is a coefficient related to a measurement gap, and measCyclePSCell is a measurement period of a PSCell.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR1.

In one subembodiment of the above embodiment, a measurement period of a PSCell is configured by the network.

In one subembodiment of the above embodiment, the first evaluation period is for a deactivated PSCell.

In one embodiment, the first evaluation period is T_{Evaluate_BFD_CSI-RS}, and the first evaluation period satisfies Max(50, Ceil(1.5×M_{BFD}×P×N×P_{BFD})×Max(measCyclePscell, T_{CSI-RS})), where Max ( ) is a function that takes a maximum value, Ceil ( ) is rounding up functions, T_{DRX} is the target DRX cycle, P is a coefficient related to a measurement gap, and measCyclePSCell is a measurement period of a PSCell.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR2.

In one subembodiment of the above embodiment, a measurement period of a PSCell is configured by the network.

In one subembodiment of the above embodiment, the first evaluation period is for a deactivated PSCell.

In one subembodiment of the embodiment, N is a scaling factor.

In one subembodiment of the embodiment, a typical value of N is 8.

In one subembodiment of the embodiment, N is used to adjust a length of a measurement period, and when a high-speed state measurement is configured, N=2.

In one embodiment, the first evaluation period is T_{Evaluate_BFD_CSI-RS_Relax}, and the first evaluation period satisfies Max(50×K3, Ceil(K1×1.5×M_{BFD}×P×P_{BFD})×Max(T_{DRX}, T_{CSI-RS})), where Max ( ) is a function that takes a maximum value, Ceil ( ) is a rounding up function, T_{CSI-RS} is a CSI-RS cycle of CSI-RS resources in T_{DRX} is the target DRX cycle, and P is a coefficient related to a measurement gap.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR1.

In one subembodiment of the above embodiment, when Max (T_{DRX}, T_{CSI-RS})≤40 ms, K1 is equal to 4; when 40<Max (T_{DRX}, T_{CSI-RS})≤80 ms, K1=2.

In one subembodiment of the above embodiment, if K1 is not greater than 2, K3=K1; otherwise K3=1.

In one subembodiment of the embodiment, the embodiment is applicable to the target DRX cycle being less than or equal to 80 ms.

In one embodiment, the first evaluation period is T_{Evaluate_BFD_CSI-RS_Relax}, and the first evaluation period satisfies Max(50×K4, Ceil(K2×1.5×M_{BFD}×P×N×P_{BFD})×Max(T_{DRX}, T_{CSI-RS})), where Max ( ) is a function that takes a maximum value, Ceil ( ) is a rounding up function, T_{CSI-RS} is a CSI-RS cycle of CSI-RS resources in q̅₀, T_{DRX} is the target DRX cycle, and P is a coefficient related to a measurement gap.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR2.

In one subembodiment of the above embodiment, K2=2.

In one subembodiment of the above embodiment, if K2 is not greater than 2, K4=K2; otherwise K4=1.

In one subembodiment of the embodiment, the embodiment is applicable to the target DRX cycle being less than or equal to 80 ms.

In one embodiment, a typical value of the M_{BFD} is 10.

In one embodiment, when a bandwidth is greater than 24 PRB, a density used for a reference signal resource of a BFD is equal to 3, and a value of the M_{BFD} is 10.

In one embodiment, P_{BFD}=1.

In one embodiment, for a PCell in NR-DC, a PCell or a PSCell in EN-DC or NE-DC or SA, P _{BFD}=1.

In one embodiment, if a BFD of an SCell is configured, P _{BFD}=2 or a multiple of 2.

In one embodiment, q̅₀ is used for beam failure detection.

In one embodiment, q̅₀ is used for beam failure recovery.

In one embodiment, q̅₀ is a reference signal resource set.

In one embodiment, q̅₀ is a set indexed by a reference signal resource.

In one embodiment, q̅₀ comprises q̅_{0,0}.

In one embodiment, q̅₀ comprises q̅_{0,0} and q̅_{0,1}.

In one subembodiment of the above embodiment, q̅_{0,0} and q̅_{0,1} are respectively for different TRPs.

In one embodiment, the first link quality evaluation comprises evaluating out-of-sync.

In one embodiment, the first link quality evaluation comprises evaluating in-sync.

In one embodiment, the first evaluation period is T_{Evaluate_BFD_SSB}, the first evaluation period satisfies Max(50, Ceil(7.5×P)×Max(m×T_{DRX},T_{SSB})), where Max ( ) is a function that takes a maximum value, Ceil ( ) is a rounding up function, T SSB is a cycle of an SSB in q̅₀, T _{DRX} is the target DRX cycle, and P is a coefficient related to a measurement gap.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR1.

In one subembodiment of the above embodiment, m is a positive number.

In one subembodiment of the above embodiment, m is equal to 1.5.

In one subembodiment of the above embodiment, m is equal to 2 or 3.

In one subembodiment of the above embodiment, m is greater than 1.

In one subembodiment of the above embodiment, m is less than 1.

In one subembodiment of the above embodiment, m is not equal to 1.

In one subembodiment of the above embodiment, m is related to the first candidate time interval set.

In one subembodiment of the above embodiment, m is related to a first offset set of the first cell group.

In one subembodiment of the above embodiment, m is related to a number of long DRX(s) of the first cell group.

In one embodiment, the first evaluation period is T_{Evaluate_BFD_SSB}, the first evaluation period satisfies Max(50, Ceil(7.5×P×N)×Max(m×T_{DRX},T_{SSB})), where Max ( ) is a function that takes a maximum value, Ceil ( ) is a rounding up function, T_{SSB} is a cycle of an SSB in q̅₀, T_{DRX} is the target DRX cycle, and P is a coefficient related to a measurement gap.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR2.

In one subembodiment of the embodiment, N is a scaling factor.

In one subembodiment of the embodiment, a typical value of N is 8.

In one subembodiment of the embodiment, N is used to adjust a length of a measurement period, and when a high-speed state measurement is configured, N=2.

In one subembodiment of the above embodiment, m is a positive number.

In one subembodiment of the above embodiment, m is equal to 1.5.

In one subembodiment of the above embodiment, m is equal to 2 or 3.

In one subembodiment of the above embodiment, m is greater than 1.

In one subembodiment of the above embodiment, m is less than 1.

In one subembodiment of the above embodiment, m is not equal to 1.

In one subembodiment of the above embodiment, m is related to the first candidate time interval set.

In one subembodiment of the above embodiment, m is related to a first offset set of the first cell group.

In one subembodiment of the above embodiment, m is related to a number of long DRX(s) of the first cell group.

In one embodiment, the first evaluation period is T_{Evaluate_out_CSI-RS}, and the first evaluation period satisfies Max(200, Ceil(1.5×Mₒᵤₜ×P×N)×Max(m×T_{DRX}, T_{CSI-RS})), where Max ( ) is a function that takes a maximum value, Ceil ( ) is a rounding up function, T_{CSI-RS} is a cycle of a CSI-RS used for radio link monitoring, T_{DRX} is the target DRX cycle, and P is a coefficient related to a measurement gap.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR2.

In one subembodiment of the embodiment, N is a scaling factor.

In one subembodiment of the embodiment, a typical value of N is 8.

In one subembodiment of the embodiment, N is used to adjust a length of a measurement period, and when a high-speed state measurement is configured, N=2.

In one subembodiment of the embodiment, a candidate value of M out is 20.

In one subembodiment of the above embodiment, m is a positive number.

In one subembodiment of the above embodiment, m is equal to 1.5.

In one subembodiment of the above embodiment, m is equal to 2 or 3.

In one subembodiment of the above embodiment, m is greater than 1.

In one subembodiment of the above embodiment, m is less than 1.

In one subembodiment of the above embodiment, m is not equal to 1.

In one subembodiment of the above embodiment, m is related to the first candidate time interval set.

In one subembodiment of the above embodiment, m is related to a first offset set of the first cell group.

In one subembodiment of the above embodiment, m is related to a number of long DRX(s) of the first cell group.

In one embodiment, the first evaluation period is T_{Evaluate_out_CSI-RS_Relax}, the first evaluation period satisfies Max(200×K3, Ceil(15×K1×Mₒᵤₜ×P)×Max(m×T_{DRX},T_{CSI-RS})), where Max ( ) is a function that takes a maximum value, Ceil ( ) is a rounding up function, T_{CSI-RS} is a cycle of a CSI-RS used for radio link monitoring, T_{DRX} is the target DRX cycle, and P is a coefficient related to a measurement gap.

In one subembodiment of the above embodiment, when a measurement gap is not configured, P is equal to 1.

In one subembodiment of the above embodiment, when a measurement gap is configured, P is greater than 1.

In one subembodiment of the above embodiment, P is self-determined by the first node according to a measurement gap.

In one subembodiment of the embodiment, the first evaluation period is for FR1.

In one subembodiment of the above embodiment, when Max (T_{DRX}, T_{CSI-RS})≤40 ms, K1 is equal to 4; when (T_{DRX}, T_{CSI-RS})≤80 ms, K1=2.

In one subembodiment of the above embodiment, if K1 is not greater than 2, K3=K1; otherwise K3=1.

In one subembodiment of the embodiment, the embodiment is applicable to the target DRX cycle being less than or equal to 80 ms.

In one subembodiment of the embodiment, a candidate value of Mₒᵤₜ is 20.

In one subembodiment of the above embodiment, m is a non-zero positive real number.

In one subembodiment of the above embodiment, m is equal to 1.5.

In one subembodiment of the above embodiment, m is equal to 2 or 3.

In one subembodiment of the above embodiment, m is greater than 1.

In one subembodiment of the above embodiment, m is less than 1.

In one subembodiment of the above embodiment, m is not equal to 1.

In one subembodiment of the above embodiment, m is related to the first candidate time interval set.

In one subembodiment of the above embodiment, m is related to a first offset set of the first cell group.

In one subembodiment of the above embodiment, m is related to a number of long DRX(s) of the first cell group.

In one embodiment, q̅₀ comprises q̅_{0,1}.

### Embodiment 10

Embodiment 10 illustrates a schematic diagram of a first time length and K being used together to determine a second time length according to one embodiment of the present application, as shown in FIG. 10.

In one embodiment, when a time interval between any two adjacent time windows in the first time window set is equal, K is equal to 1; when a time interval between any two adjacent time windows in the first time window set is a candidate time interval in a first candidate time interval set and the first candidate time interval set comprises at least a first time interval and a second time interval, K being greater than 1.

In one embodiment, K is a positive integer.

In one embodiment, K is a positive integer greater than 1.

In one embodiment, K is a number of DRX group(s) corresponding to the first cell group.

In one embodiment, K is a number of DRX configuration(s) comprised in a DRX configuration list for the first cell group.

In one embodiment, K is a number of DRX configuration(s) comprised in a DRX configuration list for the first MAC entity.

In one embodiment, K is a number of time length(s) comprised in the first time length set.

In one embodiment, K is a number of time length(s) comprised in the first time length set+1.

In one embodiment, K is a number of candidate time interval(s) comprised in the first candidate time interval set.

In one embodiment, K is a number of candidate time interval(s) comprised in the first candidate time interval set+1.

In one embodiment, K is a number of element(s) comprised in the first time window template set.

In one embodiment, K is a number of time window(s) comprised in the first time window set within a DRX cycle.

In one embodiment, K is a number of time window(s) in the first time window set comprised within a time interval determined by a first time length.

In one embodiment, K is a number of element(s) comprised in the first offset set.

In one embodiment, K is a number of element(s) comprised in the first offset set+1.

In one embodiment, the first signaling explicitly indicates K.

In one embodiment, the second time length satisfies T1/K, where T1 is the first time length.

In one embodiment, the second time length satisfies T1/(K+1), where T1 is the first time length.

In one embodiment, the second time length satisfies T1/(K−1), where T1 is the first time length, and (K−1)>1.

In one embodiment, the second time length satisfies T1/Ceil (K+1), where T1 is the first time length and Ceil ( ) is rounding up to an integer.

In one embodiment, the second time length satisfies T1/Ceil (K−1), where T1 is the first time length, (K−1)>1 and Ceil ( ) is rounding up to an integer.

In one embodiment, the second time length satisfies T1×K, where T1 is the first time length.

In one embodiment, the second time length satisfies T1×(K+1), where T1 is the first time length.

In one embodiment, the second time length satisfies T1×(K−1), where T1 is the first time length, and (K−1)>1.

### Embodiment 11

Embodiment 11 illustrates a schematic diagram of a target DRX cycle being used to determine a first indication interval according to one embodiment of the present application, as shown in FIG. 11.

In one embodiment, the first indication interval comprises T_{Indication_interval}.

In one embodiment, as a response to the behavior of executing a first link quality evaluation, a physical layer of the first node transmits a first-type indication to a higher layer.

In one embodiment, the behavior of executing a first link quality evaluation comprises that a physical layer of the first node transmits a first-type indication to a higher layer.

In one embodiment, a minimum value of a time interval between two successive first-type indications is the first indication interval.

In one embodiment, the first indication interval satisfies Max (10 ms, 1.5×DRX_cycle_length, 1.5×T_{RLM-RSM})), where Max ( ) is a maximum value function, DRX_cycle_length is the target DRX cycle, T_{RLM-RS, M} is a shortest period of all configured radio link monitoring reference signal resources of a cell on which a link quality monitoring is executed.

In one subembodiment of the above embodiment, the first indication interval is T_{Indication_interval}.

In one subembodiment of the above embodiment, the first link quality evaluation is radio link monitoring.

In one embodiment, the first indication interval satisfies Max(1.5×DRX_cycle_length, 1.5×T_{SSB-RS,M}), where Max( ) is a function that takes a maximum value, DRX_cycle_length is the target DRX cycle, T_{SSS-RS}, M is a minimum value of a cycle of all SSB reference signal resources in q̅₀.

In one subembodiment of the above embodiment, the first indication interval is T_{Indicaton_interval_BFD}.

In one subembodiment of the above embodiment, the first link quality evaluation is or comprises a beam failure detection.

In one subembodiment of the above embodiment, the first link quality evaluation is or comprises a beam failure recovery.

In one subembodiment of the above embodiment, the first link quality evaluation is for a link recovery.

In one embodiment, the first indication interval satisfies Max(1.5×DRX_cycle_length, 1.5×T_{CSI-RS-RS,M}), where Max( ) is a function that takes a maximum value, DRX_cycle_length is the target DRX cycle, T_{SSB-RS,M} is a minimum value of a cycle of all CSI-RS reference signal resources in q̅₀.

In one subembodiment of the above embodiment, the first indication interval is T_{Indicaton_interval_BFD}.

In one subembodiment of the above embodiment, the first link quality evaluation is or comprises a beam failure detection.

In one subembodiment of the above embodiment, the first link quality evaluation is or comprises a beam failure recovery.

In one subembodiment of the above embodiment, the first link quality evaluation is for a link recovery.

### Embodiment 12

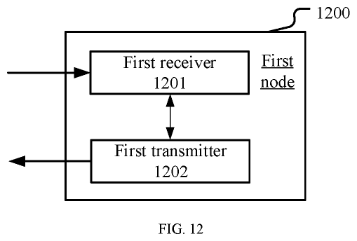

Embodiment 12 illustrates a structure block diagram of a processor in a first node according to one embodiment of the present application, as shown in FIG. 12. In FIG. 12, a processor 1200 in a first node comprises a first receiver 1201 and a first transmitter 1202. In Embodiment 12,
the first receiver 1201 receives a first signaling, the first signaling comprises a first parameter set, the first parameter set is used to configure a DRX of a first cell group; the DRX configured by the first parameter set is for a first MAC entity;
the first receiver 1201, within an active time of the first MAC entity, monitors a PDCCH;
the first receiver 1201 executes a first link quality evaluation, a time of the behavior of executing a first link quality evaluation is a first evaluation period;
herein, the first parameter set comprises a first time length set, and the first time length set comprises at least a first time length; any time length in the first time length set is a first-type DRX cycle; a system frame number, a subframe number, and the first time length set are used together to determine a first time window set; the active time of the first MAC entity comprises the first time window set; a target DRX cycle is used to determine the first evaluation period; the target DRX cycle is related to whether a time interval between any two adjacent time windows in the first time window set is equal; when a time interval between any two adjacent time windows in the first time window set is equal, the target DRX cycle is equal to the first time length; when a time interval between any two adjacent time windows in the first time window set is a candidate time interval in a first candidate time interval set and the first candidate time interval set comprises at least a first time interval and a second time interval, the target DRX cycle is equal to a second time length; the first time length is not equal to the second time length; a DRX configured by the first parameter set is unrelated to PTM.

In one embodiment, the first time length set is used to determine the second time length;
herein, the meaning of the phrase that the first time length set is used to determine the second time length is: the second time length is an extreme value of a time length comprised in the first time length set; the first time length set comprises multiple time lengths.

In one embodiment, the first time length set is used to determine the second time length;
herein, the meaning of the phrase that the first time length set is used to determine the second time length is: the second time length is an average value of time lengths comprised in the first time length set; the first time length set comprises multiple time lengths.

In one embodiment, the first signaling comprises the second time length.

In one embodiment, the first time length set only comprises the first time length; a number of DRX(s) configured in the first parameter set is K, where K is a positive integer greater than 1; the first time length and K are used together to determine the second time length.

In one embodiment, any time window within the first time window set corresponds to a running of a first-type DRX timer; a name of the first-type DRX timer comprises onduration.

In one embodiment, the first time length set only comprises the first time length; any DRX cycle determined by the first time length comprises K time windows in the first time window set, and the first time length and K are used together to determine the second time length.

In one embodiment, the meaning of the phrase that a target DRX cycle is used to determine the first evaluation period comprises: the target DRX cycle and a first coefficient are used together to determine the first evaluation period, when a time interval between any two adjacent time windows in the first time window set is equal, the first coefficient is equal to 1; when a time interval between any two adjacent time windows in the first time window set is a candidate time interval in a first candidate time interval set and the first candidate time interval set comprises at least a first time interval and a second time interval, the first coefficient is not equal to 1;
In one embodiment, a first indication interval is a minimum interval between two adjacent evaluation results of the first link quality evaluation indicated by a physical layer of the first node to a higher layer;
the target DRX cycle is used to determine the first indication interval.

In one embodiment, the first node is a UE.

In one embodiment, the first node is a terminal that supports large delay differences.

In one embodiment, the first node is a terminal that supports NTN.

In one embodiment, the first node is an aircraft or vessel.

In one embodiment, the first node is a mobile phone or vehicle terminal.

In one embodiment, the first node is a relay UE and/or U2N remote UE.

In one embodiment, the first node is an Internet of Things terminal or an Industrial Internet of Things terminal.

In one embodiment, the first node is a device that supports transmission with low-latency and high-reliability.

In one embodiment, the first node is a sidelink communication node.

In one embodiment, the first receiver 1201 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1202 comprises at least one of the antenna 452, the transmitter 454, the transmitting processor 468, the multi-antenna transmitting processor 457, the controller/processor 459, the memory 460 or the data source 467 in Embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, RFID terminals, NB-IOT terminals, Machine Type Communication (MTC) terminals, enhanced MTC (eMTC) terminals, data cards, low-cost mobile phones, low-cost tablet computers, satellite communication equipment, vessel communication equipment, NTN UEs, etc. The base station or system device in the present application includes but is not limited to macro-cellular base stations, micro-cellular base stations, home base stations, relay base station, gNB (NR node B), Transmitter Receiver Point (TRP), NTN base stations, satellite equipment, flight platform equipment and other radio communication equipment.

This application can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling, the first signaling comprising a first parameter set, the first parameter set being used to configure a Discontinuous Reception (DRX) of a first cell group; the DRX configured by the first parameter set is for a first MAC entity;
the first receiver, within an active time of the first Media Access Control (MAC) entity, monitoring a Physical downlink Control Channel (PDCCH); and
the first receiver, executing a first link quality evaluation, a time of the behavior of executing a first link quality evaluation being a first evaluation period;
wherein the first parameter set comprises a first time length set, and the first time length set comprises at least a first time length; any time length in the first time length set is a first-type DRX cycle; a system frame number, a subframe number, and the first time length set are used together to determine a first time window set; the active time of the first MAC entity comprises the first time window set; a target DRX cycle is used to determine the first evaluation period; the target DRX cycle is related to whether a time interval between any two adjacent time windows in the first time window set is equal; when a time interval between any two adjacent time windows in the first time window set is equal, the target DRX cycle is equal to the first time length; when a time interval between any two adjacent time windows in the first time window set is a candidate time interval in a first candidate time interval set and the first candidate time interval set comprises at least a first time interval and a second time interval, the target DRX cycle is equal to a second time length; the first time length is not equal to the second time length; a DRX configured by the first parameter set is unrelated to Point to Multipoint (PTM).

2. The first node according to claim 1, wherein
the first time length set is used to determine the second time length;
wherein the meaning of the phrase that the first time length set is used to determine the second time length is: the second time length is an extreme value of a time length comprised in the first time length set; the first time length set comprises multiple time lengths.

3. The first node according to claim 1, wherein
the first time length set is used to determine the second time length;
wherein the meaning of the phrase that the first time length set is used to determine the second time length is: the second time length is an average value of time lengths comprised in the first time length set; the first time length set comprises multiple time lengths.

4. The first node according to claim 1, wherein
the first signaling comprises the second time length.

5. The first node according to claim 1, wherein
the first time length set only comprises the first time length; a number of DRX(s) configured in the first parameter set is K, where K is a positive integer greater than 1; the first time length and K are used together to determine the second time length.

6. The first node according to claim 5, wherein
any time window within the first time window set corresponds to a running of a first-type DRX timer; a name of the first-type DRX timer comprises onduration.

7. The first node according to claim 1, wherein
the first time length set only comprises the first time length; any DRX cycle determined by the first time length comprises K time windows in the first time window set, and the first time length and K are used together to determine the second time length.

8. The first node according to claim 5, wherein
the meaning of the phrase that a target DRX cycle is used to determine the first evaluation period comprises: the target DRX cycle and a first coefficient are used together to determine the first evaluation period, when a time interval between any two adjacent time windows in the first time window set is equal, the first coefficient is equal to 1; when a time interval between any two adjacent time windows in the first time window set is a candidate time interval in a first candidate time interval set and the first candidate time interval set comprises at least a first time interval and a second time interval, the first coefficient is not equal to 1.

9. The first node according to claim 6, wherein
the meaning of the phrase that a target DRX cycle is used to determine the first evaluation period comprises: the target DRX cycle and a first coefficient are used together to determine the first evaluation period, when a time interval between any two adjacent time windows in the first time window set is equal, the first coefficient is equal to 1; when a time interval between any two adjacent time windows in the first time window set is a candidate time interval in a first candidate time interval set and the first candidate time interval set comprises at least a first time interval and a second time interval, the first coefficient is not equal to 1.

10. The first node according to claim 7, wherein
the meaning of the phrase that a target DRX cycle is used to determine the first evaluation period comprises: the target DRX cycle and a first coefficient are used together to determine the first evaluation period, when a time interval between any two adjacent time windows in the first time window set is equal, the first coefficient is equal to 1; when a time interval between any two adjacent time windows in the first time window set is a candidate time interval in a first candidate time interval set and the first candidate time interval set comprises at least a first time interval and a second time interval, the first coefficient is not equal to 1.

11. The first node according to claim 10, comprising:
a first indication interval is a minimum interval between two adjacent evaluation results of the first link quality evaluation indicated by a physical layer of the first node to a higher layer;
the target DRX cycle is used to determine the first indication interval.

12. The first node according to claim 4, wherein
a first indication interval is a minimum interval between two adjacent evaluation results of the first link quality evaluation indicated by a physical layer of the first node to a higher layer;
the target DRX cycle is used to determine the first indication interval.

13. The first node according to claim 6, wherein
a first indication interval is a minimum interval between two adjacent evaluation results of the first link quality evaluation indicated by a physical layer of the first node to a higher layer;
the target DRX cycle is used to determine the first indication interval.

14. The first node according to claim 10, wherein
a first indication interval is a minimum interval between two adjacent evaluation results of the first link quality evaluation indicated by a physical layer of the first node to a higher layer;
the target DRX cycle is used to determine the first indication interval.

15. The first node according to claim 1, wherein
a DRX configured by the first parameter set is a long DRX.

16. The first node according to claim 1, wherein
the first time window set is unrelated to a running state of a DRX inactivity timer of the first MAC entity.

17. The first node according to claim 1, wherein
the first node is not configured to monitor a Downlink Control Information with CRC scrambled by Power Saving Radio Network Temporary Identity (DCP).

18. The first node according to claim 1, comprising:
the first receiver, receiving first QoS information; the first QoS information is used to indicate at least one of the first time interval, the second time interval or the first time length set; the first QoS information is for a first service;
the first service is an interactive service.

19. The first node according to claim 1, wherein
the first parameter set comprises a first template used for determining the first time window set, the first template is used to indicate a first time window template set, and the first time window template set comprises more than one discontiguous time window; the first time window template set and a specific offset are used together to generate or determine the first time window set.

20. A method in a first node for wireless communications, comprising:
receiving a first signaling, the first signaling comprising a first parameter set, the first parameter set being used to configure a DRX of a first cell group; the DRX configured by the first parameter set being for a first MAC entity;
within an active time of the first MAC entity, monitoring a PDCCH; and
executing a first link quality evaluation, a time of the behavior of executing a first link quality evaluation being a first evaluation period;
wherein the first parameter set comprises a first time length set, and the first time length set comprises at least a first time length; any time length in the first time length set is a first-type DRX cycle; a system frame number, a subframe number, and the first time length set are used together to determine a first time window set; the active time of the first MAC entity comprises the first time window set; a target DRX cycle is used to determine the first evaluation period; the target DRX cycle is related to whether a time interval between any two adjacent time windows in the first time window set is equal; when a time interval between any two adjacent time windows in the first time window set is equal, the target DRX cycle is equal to the first time length; when a time interval between any two adjacent time windows in the first time window set is a candidate time interval in a first candidate time interval set and the first candidate time interval set comprises at least a first time interval and a second time interval, the target DRX cycle is equal to a second time length; the first time length is not equal to the second time length; a DRX configured by the first parameter set is unrelated to PTM.
